(19) United States
(12) Patent Application Publication
(10) Pub. No.: US 2024/0408816 A1
(43) Pub. Date: Dec. 12, 2024

(54) Bioprinting of Collagenous Bioinks

(71) Applicant: Yale University, New Haven, CT (US)

(72) Inventors: Michael Mak, New Haven, CT (US); Xiangyu Gong, New Haven, CT (US); Zixie Liang, New Haven, CT (US)

(21) Appl. No.: 18/653,162

(22) Filed: May 2, 2024

Related U.S. Application Data
(60) Provisional application No. 63/499,607, filed on May 2, 2023.

(51) Int. Cl. B29C 64/209; B33Y 70/10

(52) U.S. Cl. CPC B29C 64/209; B33Y 70/10

(57) ABSTRACT

The present invention provides methods for bioprinting collagen and extracellular matrix-based bioinks, and articles such as engineered tissues, comprising the bioinks. In other aspects, the present invention relates to a bioprinting system including a 3D bioprinter with a nozzle, at least one bioink, a support bath solution, wherein the support bath solution comprises PEG (polyethylene glycol) and agarose.

### CROSS-REFERENCE TO RELATED APPLICATIONS

This application claims priority to U.S. Provisional Application No. 63/499,607 filed on May 2, 2023, incorporated herein by reference in its entirety.

### STATEMENT REGARDING FEDERALLY SPONSORED RESEARCH OR DEVELOPMENT

This invention was made with government support under Grant Number R35GM142875 awarded by the National Institute of Health. The government has certain rights in the invention.

### BACKGROUND OF THE INVENTION

Tissues in the body are composed of complex 3D patterns of cells and the extracellular matrix (ECM). These patterns are difficult to recapitulate with conventional tissue culture techniques (e.g. embedding cells in a hydrogel). Bioprinting offers promise toward the generation of in vitro tissues with unparalleled geometric realism for (patho)physiological modeling and regenerative medicine. Accurate 3D positional control and an appropriate bioink “curing” mechanism enable many tissue architectures to be fabricated, including tubes, domes, solid or hollow shapes, and vessel networks of various topologies. Extrusion bioprinting, in which ink is extruded from a nozzle, is a common bioprinting solution owing to its flexibility and ease of adaptability with existing commercial 3D printers.

A grand challenge in bioprinting is the choice and development of the right bioink. Common bioinks include alginate and gelatin methacryloyl (GelMa), which offer excellent printability (easily extrudable and subsequently controllably and rapidly gelled). While these bioinks are demonstrated to maintain cell viability (an initial assessment of biocompatibility), they are non-physiological materials, and demonstration of complex physiological functions of printed tissues using these bioinks is limited. Physiological materials, i.e. natural ECM components, are ideal for promoting physiological bioactivity, but they are not easily printable due to challenges in precisely controlling their gelation after extrusion. For example, solubilized collagen I, a prominent ECM component in the body used for many 3D tissue culture studies, typically requires a duration of tens of minutes to gel, which disrupts patterning accuracy and fidelity due to diffusion and sedimentation (e.g. of cells) during the gelation period after extrusion.

One prominent method for bioprinting collagen is known as FRESH (Free-form Reversible Embedding of Suspended Hydrogels), in which a slurry support bath is used to maintain 3D positional accuracy of extruded bioinks. This method successfully bioprinted acid solubilized collagen I as the bioink, but at very high concentrations (typically 24 mg/mL). A key working mechanism of this method is the rapid gelation of high concentration acidic collagen solutions upon neutralization in a neutralized support bath. The acidity in the collagen solution is required to maintain its liquid form before extrusion (so that it is extrudable), and the high collagen concentration is required to enable fast gelation upon extrusion (gelation speed is concentration dependent)—these requirements enable the printability of collagen I using the FRESH method. However, this mechanism limits flexibility and possible applications, as the acidity of the ink reduces cell viability and poses a challenge for bioprinting cell-laden collagen solutions as the bioink, and the high concentration is limited to tissues where such concentrations are applicable or desired. Typical collagen concentrations in in vitro studies that promote cell activities such as cell spreading and migration are ˜ 1 to 4 mg/mL, where pore size and ECM stiffness are among important biophysical determinants of cell behaviors.

Thus, there is a pressing need in the art to develop novel collagenous bioinks that allow versatile, high-fidelity, and cell-laden printing of collagenous solutions. The present invention meets this need.

### SUMMARY OF THE INVENTION

In some aspects, the present invention relates to a bioprinting system including a 3D bioprinter with a nozzle, at least one bioink, a support bath solution, wherein the support bath solution comprises PEG (polyethylene glycol) and agarose.

In some embodiments, the at least one bioink includes at least one material selected from the group consisting of: collagen I, ECM proteins, fibrin, basement membrane proteins, Matrigel, Geltrex, collagen IV, laminin, collagen of any type from any species, growth factors, cell culture media, phosphate-buffered saline (PBS), any pH buffering solution, NaOH, any PH neutralizing or modifying solution, glycosaminoglycans, hyaluronic acid, dextran, acid solubilized collagen I solution, neutralized collagen I solution, solution of pre-formed collagen fibers or fiber bundles. In some embodiments, the at least one bioink further includes one or more cells selected from the group consisting of: induced pluripotent stem cells, stem cells of any type, endothelial cells, primary cells, cell lines, cancer cells, or mammalian cells, any cell type.

In some embodiments, the support bath further includes materials selected from the group consisting of: agarose, agarose slurry, gelatin, gelatin slurry, PBS, water, water-soluble polymer, PEG of molecular weight 8000 Da, PEG of molecular weight 20000 Da, PEG of any molecular weight between 8000 and 20000 Da, PEG of any molecular weight between 0-8000 Da, PEG of any molecular weight, methylcellulose, dextran, and any viscosity modifying reagent.

In some embodiments, the nozzle has one or more lumens, and one or more bioink reservoirs fluidly connected to the one or more lumens. In some embodiments, the nozzle has a first and second lumen, a first bioink reservoir fluidly connected to the first lumen, and a second bioink reservoir fluidly connected to the second lumen. In some embodiments, the first bioink is a collagenous bioink, and the second bioink is PEG. In some embodiments, the bioprinting system further includes a bioprinting receptacle for holding the support bath solution.

In some aspects, the present invention relates to a method of printing a biological structure, having the steps of providing any bioprinting system of the present invention, submerging the nozzle of the bioprinter into the support bath solution, extruding the at least one bioink into the support bath solution, and forming a 3D structure with the bioink.

In some embodiments, the method further includes the step of extracting the biological structure out of the support bath solution. In some embodiments, the method further includes the step of washing the support bath solution away from the biological structure. In some embodiments, the method further includes the step of seeding the biological structure with one or more cells after the extracting and washing steps. In some embodiments, the method further includes the step of dehydrating the biological structure. In some embodiments, the method further includes the step of crosslinking the biological structure with one or more crosslinking agents. In some embodiments, the method further includes the step of conditioning the biological structure with mechanical conditioning. In some embodiments, the method further includes the step of culturing the biological structure in a bioreactor.

Aspects of the present invention relate to a biological structure, as printed by the steps of any disclosed method. In some embodiments, the biological structure is any of a soft tissue structure, a cartilaginous structure, a connective tissue structure, a vascular tissue structure, vascular graft structure, a luminal structure, a hollow structure, and a bone tissue structure. In some embodiments, the biological structure is in the shape of an articular cartilage, a nasal cartilage, a tarsal plate, tracheal rings, thyroid cartilage, and arytenoid cartilage.

In some embodiments, the biological structure is formed as a bone, dental structure, joint, cartilage, skeletal muscle, smooth muscle, cardiac muscle, tendon, menisci, ligament, blood vessel, stent, heart valve, cornea, ear drum, nerve guide, tissue patch or sealant, or a filler for missing tissues and skin. In some embodiments, the biological structure has a dimension less than 25 μm. In some embodiments, the diameter of the biological structure is less than 25 μm. In some embodiments, the printed structure is extracted from the support bath. In some embodiments, the biological structure is modified after bioprinting by dehydration and crosslinking with genipin.

In some embodiments, the biological structure is seeded or coated with cells after bioprinting, such as coating with endothelial cells or other cell types. In some embodiments, biological structure is subsequently cultured, such as in a bioreactor. In some embodiments, the biological structure is used for therapeutic applications such as vascular grafting. In some embodiments, the biological structure is used for in vitro studies. In some embodiments, the biological structure is modified after bioprinting by chemical or physical factors, such as crosslinking or mechanical conditioning.

In some embodiments, the biological structure is modified after bioprinting in any way. In some embodiments, the components of the system can be of any ratio and any concentration. In some embodiments, the concentration of the support bath materials, such as PEG, is tuned to tune the gelation or solidification speed of the printed bioink. In some embodiments, the printed layers are merged by overfilling each layer with excess or slightly excess bioink material. In some embodiments, the printing is performed at different extrusion rate or nozzle translation speeds.

In some embodiments, the resolution of the printed feature is altered by changing the translational speed of the nozzle during printing. In some embodiments, the resolution of the printed feature is altered by changing the extrusion rate of the bioink from the nozzle. In some embodiments, the resolution of the printed feature is altered by changing the concentration of support bath components. In some embodiments, the resolution of the printed feature is altered by changing the diameter of the nozzle opening. In some embodiments, the resolution of the printed feature is altered by modifying by any of: translational speed of the nozzle during printing, extrusion rate of the bioink during printing, nozzle diameter size, support bath components, bioink components.

In some aspects, the present invention relates to a bioprinting system including a 3D bioprinter with a nozzle, at least one bioink, a support bath solution, wherein the bioink comprises PEG (polyethylene glycol) and agarose, and the support bath solution is a collagenous solution. In some embodiments, the support bath solution comprises collagen I.

In some aspects, the present invention relates a method of printing a biological structure, having the steps of providing any disclosed system of the present invention, submerging the nozzle of the bioprinter into the support bath solution, extruding the at least one bioink into the support bath solution, forming a 3D structure with the bioink.

In some aspects, the present invention relates to a biological structure as printed by any disclosed method. In some embodiments, the 3D structure is a hollow or luminal structure.

### BRIEF DESCRIPTION OF THE DRAWINGS

The following detailed description of invention will be better understood when read in conjunction with the appended drawings. It should be understood, however, that the invention is not limited to the precise arrangements and instrumentalities of the embodiments shown in the drawings.

FIG. 1 is a flowchart depicting an exemplary method of preparing a bioink according to aspects of the present invention.

FIG. 2 is a flowchart depicting an exemplary method of preparing a macromolecular bath solution according to aspects of the present invention.

FIG. 3 through FIG. 8 depicts bioprinting of a bioink into a macromolecular bath solution to form 3D constructs according to aspects of the present invention.

FIG. 3 shows bioprinting of a free-form design.

FIG. 4 shows bioprinting of a gourd design.

FIG. 5 shows bioprinting of an iPSC-laden tube and an iPSC-laden cardiac ventricle.

FIG. 6 shows bioprinting of a continuous collagen filament.

FIG. 7 shows bioprinting of vascular grafts and/or collagen vessels having high aspect ratio.

FIG. 8 shows the bioprinted 3D structures may be sutured and perfused, mimicking vascular grafting.

FIG. 9 is a flowchart depicting an exemplary method of bioprinting a bioink into a macromolecular bath solution according to aspects of the present invention.

FIG. 10 is an exemplary coaxial bioprinting setup according to aspects of the present invention.

FIG. 11 shows an exemplary 3D construct printed using a coaxial bioprinting setup according to aspects of the present invention.

FIG. 12 shows an exemplary coaxial nozzle and upwards toolpath for a coaxial bioprinting setup according to aspects of the present invention.

FIG. 13 is a flowchart depicting an exemplary method of coaxial bioprinting a first and second bioink into a macromolecular bath solution according to aspects of the present invention.

FIG. 14A depicts an exemplary rapid macro-scale collagen bioprinting according to aspects of the present invention.

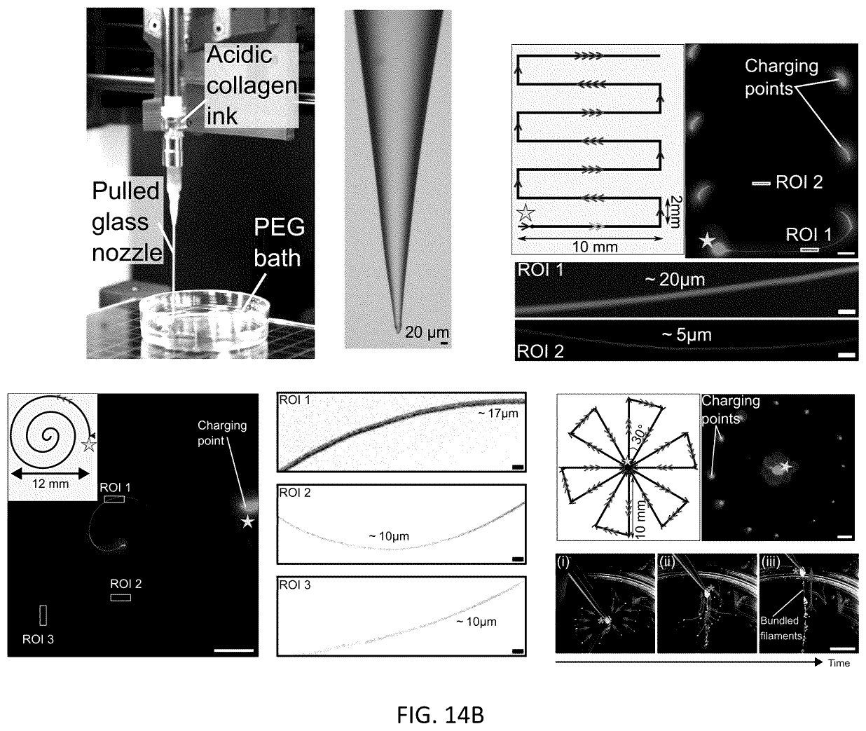

FIG. 14B depicts an exemplary rapid patterning of collagen micro-filaments according to aspects of the present invention.

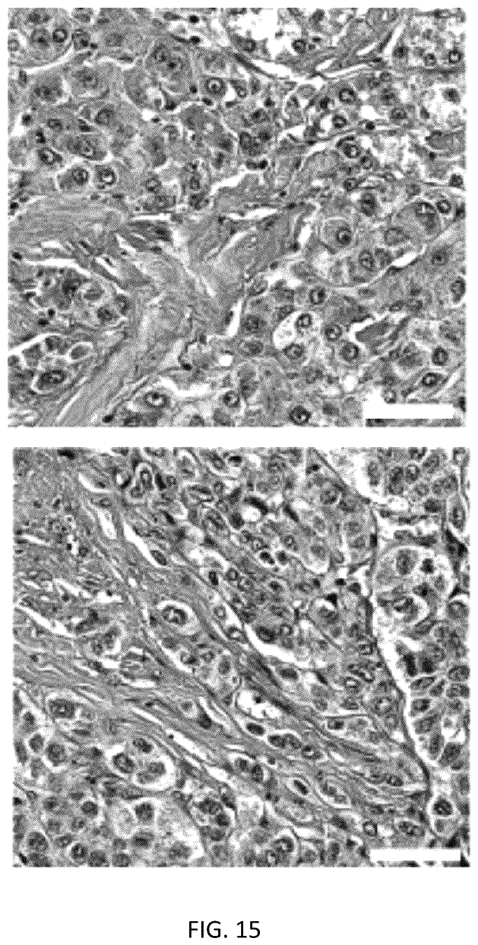

FIG. 15 shows H&E staining of fibrotic regions in patient liver sections with hepatocellular carcinoma.

FIG. 16 shows various parameters for collagen microtissue patterning (left) and a flow-chart showing steps for collagen characterization (right).

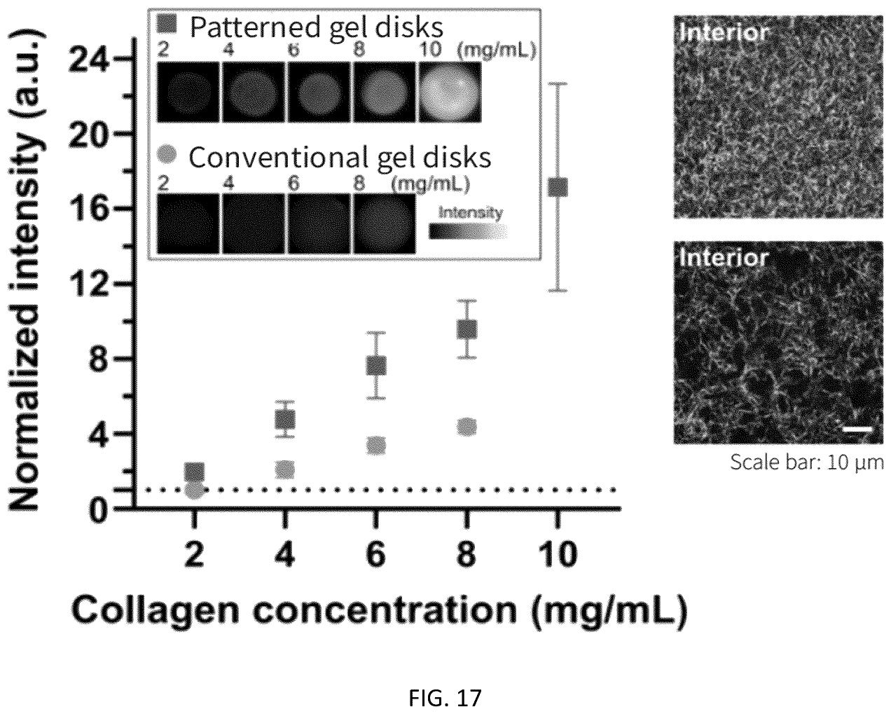

FIG. 17 shows the results for a comparison of collagen concentration to normalized intensity for patterned vs conventional gel disks indicating the tunability of patterned collagen.

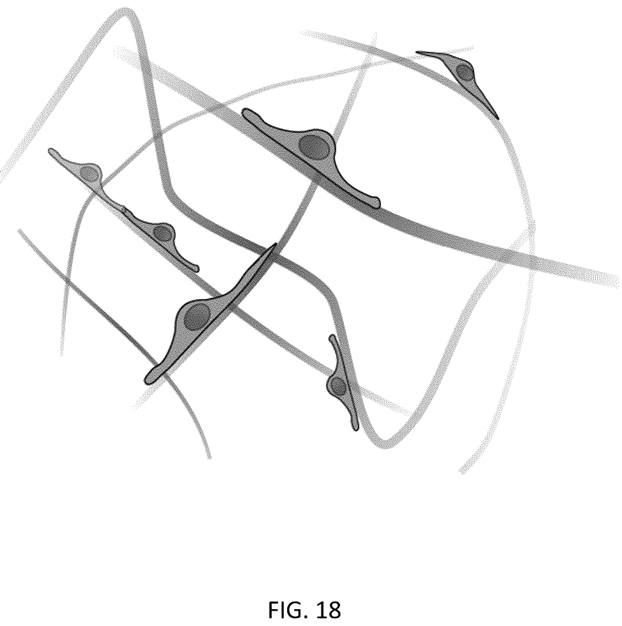

FIG. 18 shows an exemplary tunable collagen microbundle formed using the disclosed methods.

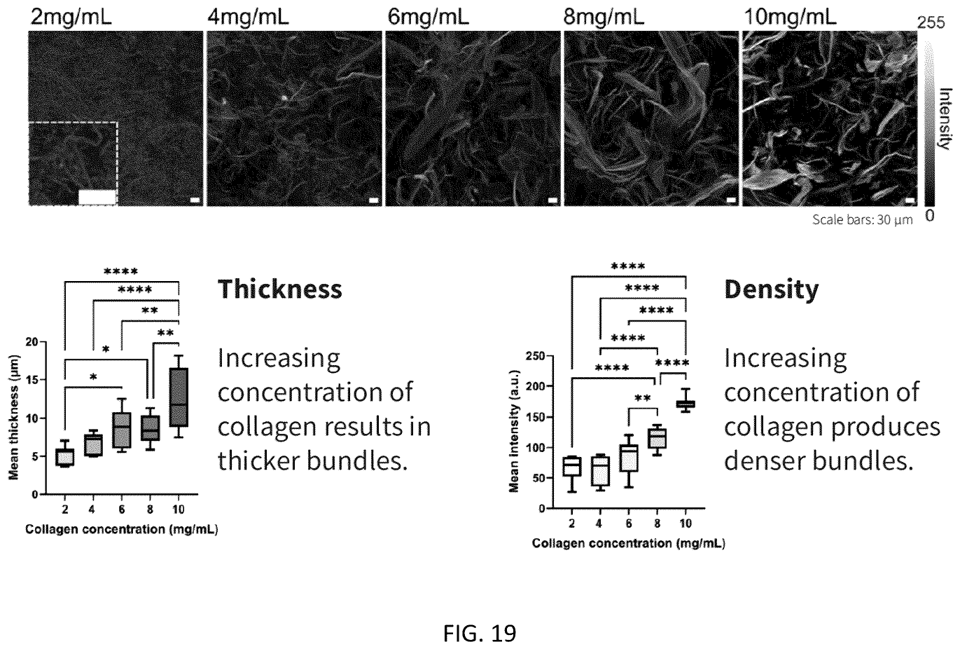

FIG. 19 shows various concentrations of collagen bundles with (top) and the results for collagen concentration vs mean thickness (bottom left) and collagen concentration vs mean intensity (bottom right).

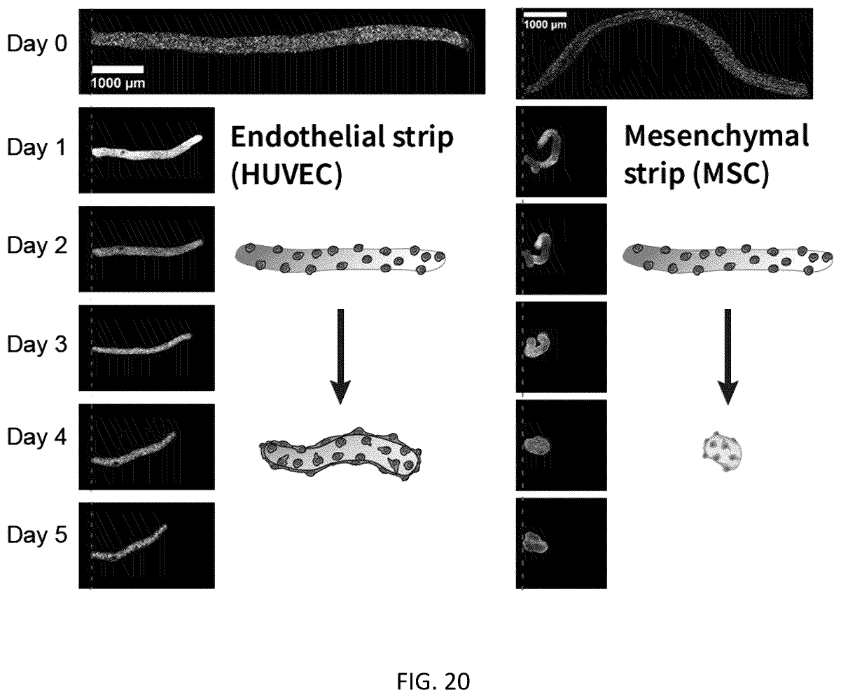

FIG. 20 shows the progression of bioprinted endothelial strips (left) and bioprinted mesenchymal strips (right) over the course of 5 days.

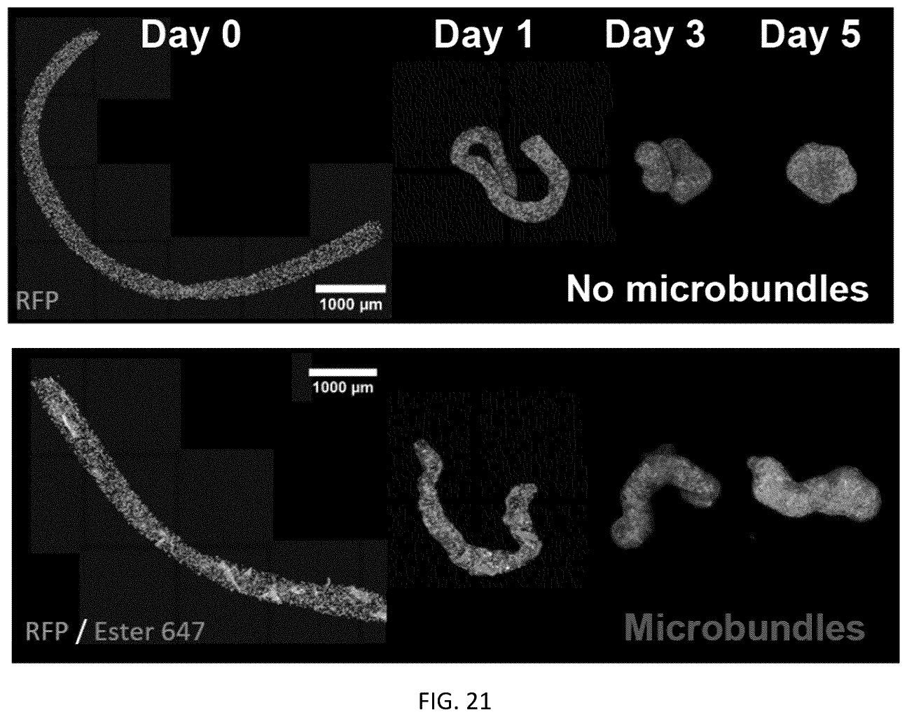

FIG. 21 shows the comparison of bioprinted constructs without collagen microbundles (top) and with collagen microbundles (bottom) over the course of 5 days.

FIG. 22 shows the growth of collagen microbundles used to create microvasculature over a period of 5 days (top), and the results for day vs scaffold area (bottom).

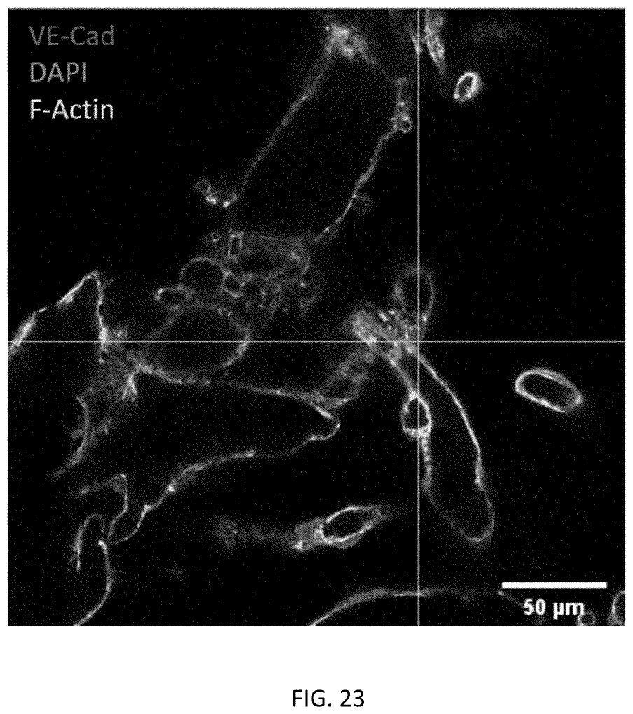

FIG. 23 shows microbundles used to create microvasculature highlighting VE-Cad (red), DAPI (blue) and F-Actin (yellow).

FIG. 24 shows the observed long-term branching outgrowth (green) that follows the initial microbundle architecture (red) for fibrin gel domes.

FIG. 25 shows collagen microbundles (magenta) mixed with hepatocarcinoma cells (green) to create tumor spheroids.

FIG. 26 shows the results for ROI 1, ROI2, Patient 1, and Patient 2 for in vitro and in vivo study, respectively.

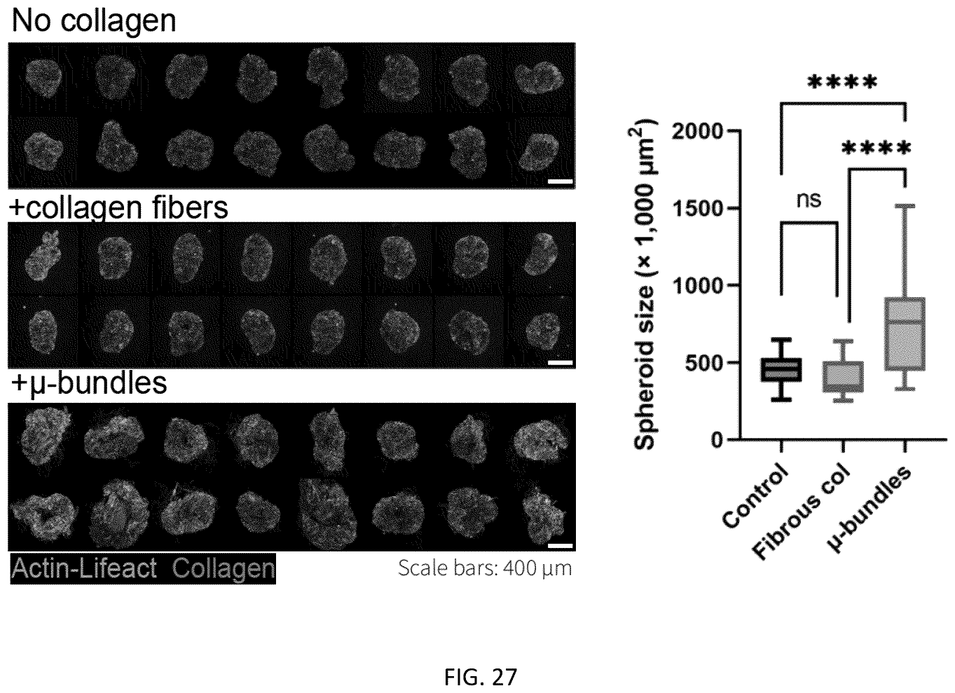

FIG. 27 shows the tumor spheroid growth for no collagen, with collagen fibers, and with collagen bundles (left) and the results for control, collagen fibers and microbundles vs spheroid size (right).

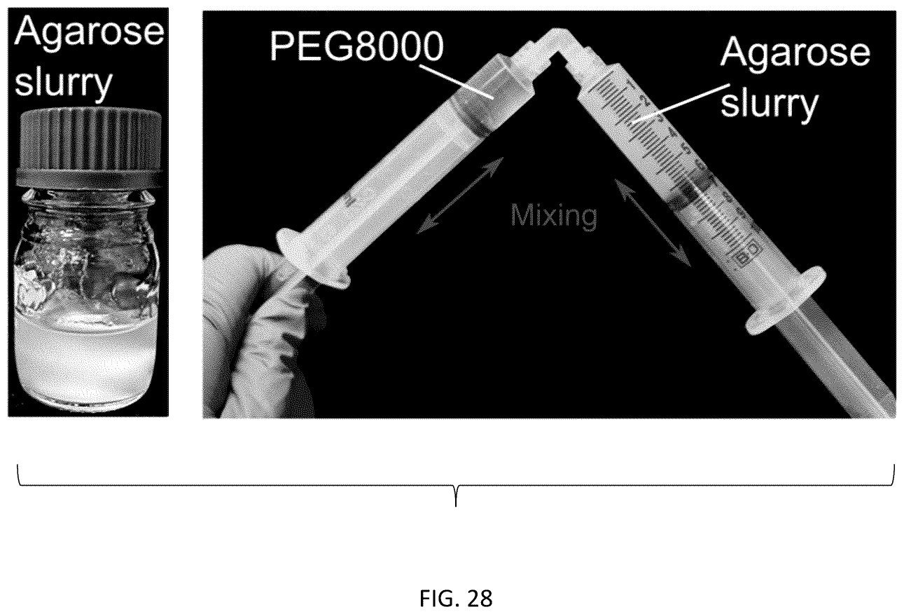

FIG. 28 depicts preparation of the support bath (TRACE bath) by mixing agarose slurry and PEG solution.

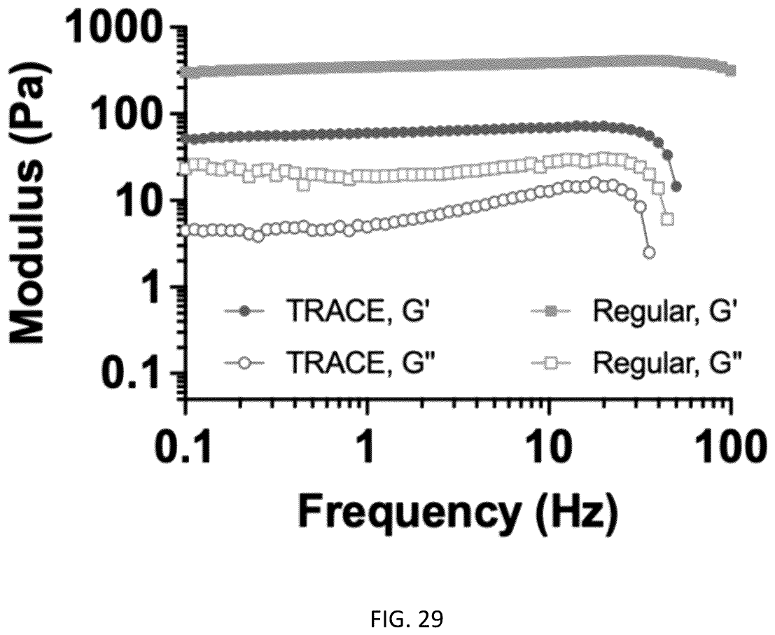

FIG. 29 shows rheological characterization on the TRACE bath and the regular slurry bath.

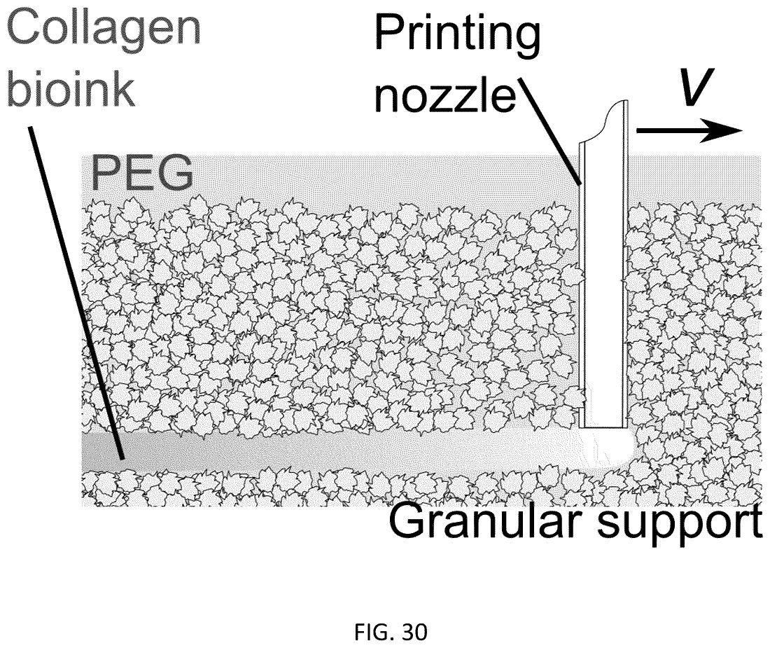

FIG. 30 depicts printing collagen bioink in a support bath that comprises agarose slurry and PEG solution.

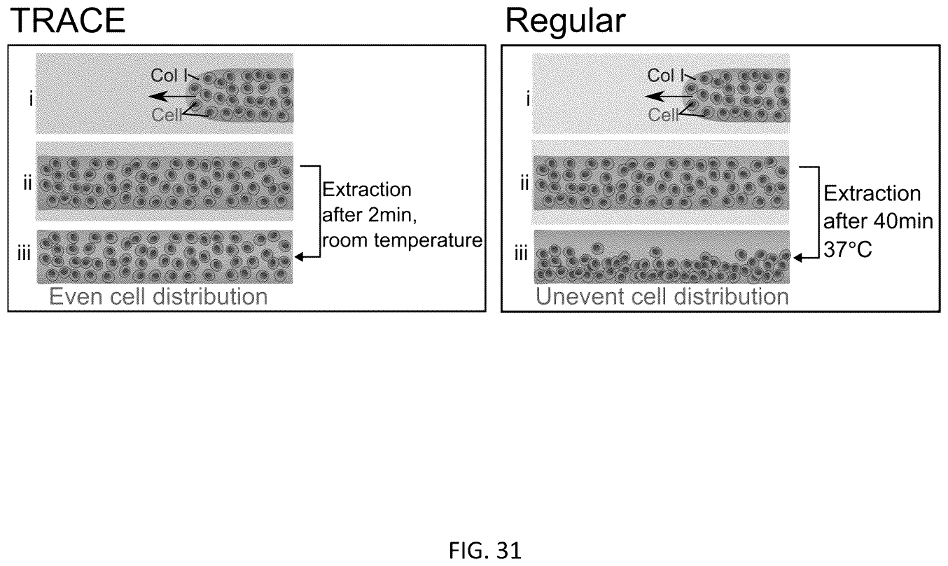

FIG. 31 shows improved cell distribution by TRACE-bath induced rapid collagen gelation, compared to the regular agarose bath without PEG.

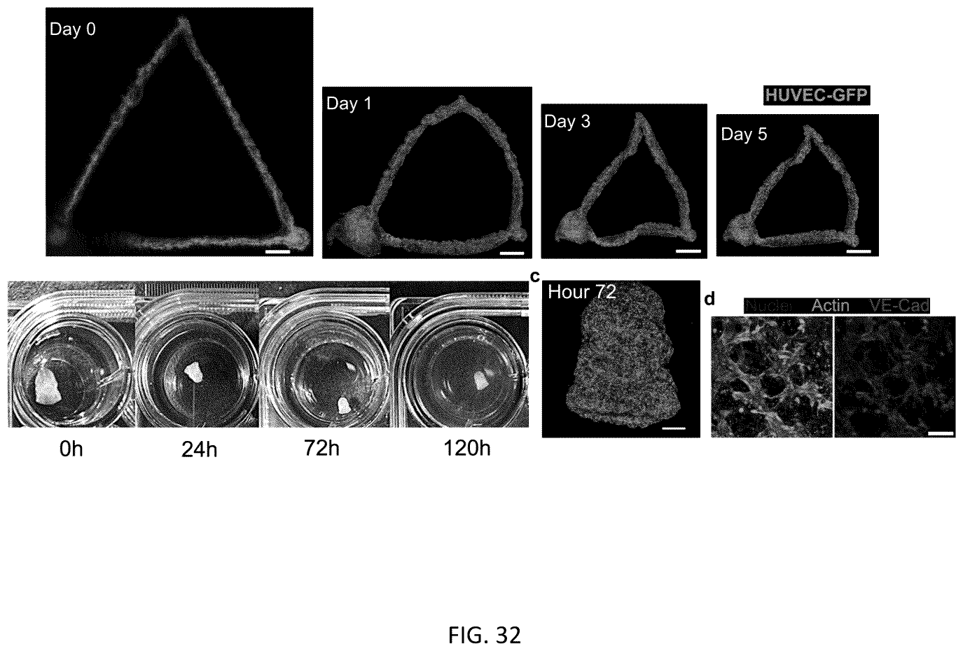

FIG. 32 depicts daily tracking of a macroscopic 2D triangular pattern and a 3D bell shaped construct printed with a collagen bioink containing HUVECs. Surface cells show expression of the microvasculature marker VE-Cad.

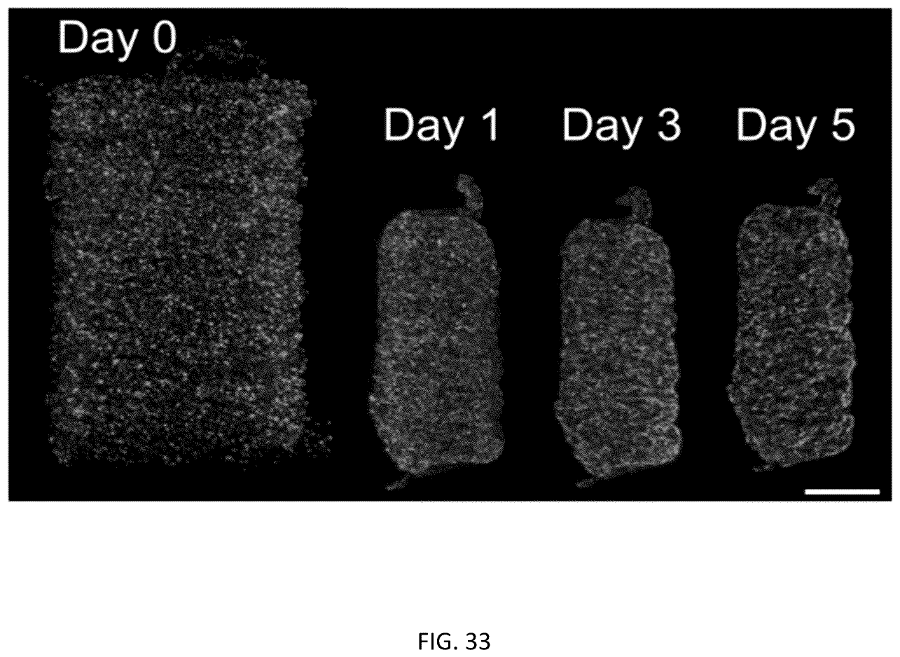

FIG. 33 depicts a live macroscopic 3D tube printed with a collagen bioink containing HUVECs on Day 0, 1, 3, 5.

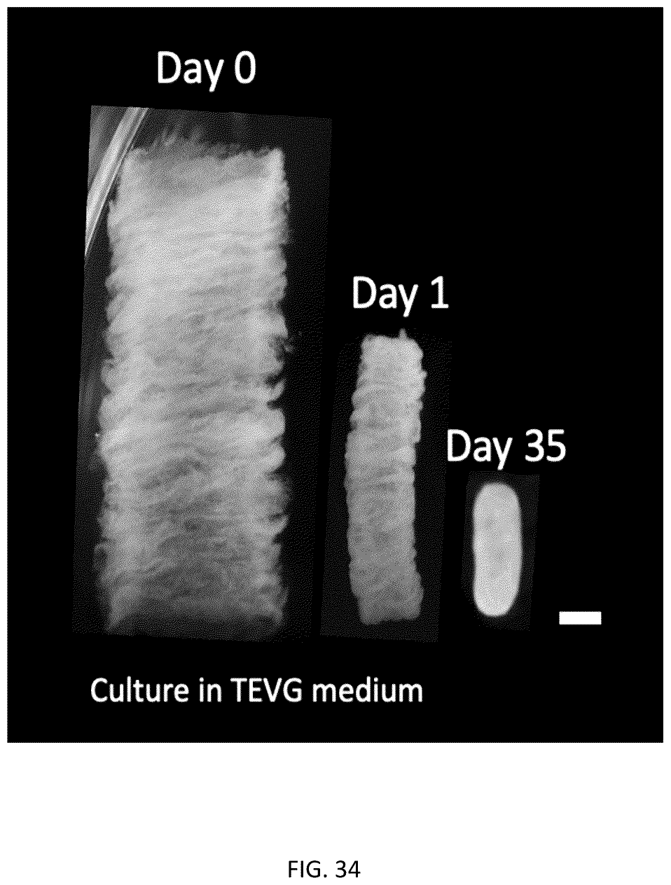

FIG. 34 depicts long term tracking of a macroscopic 3D tube printed with a collagen bioink containing bovine smooth muscle cells (SMCs).

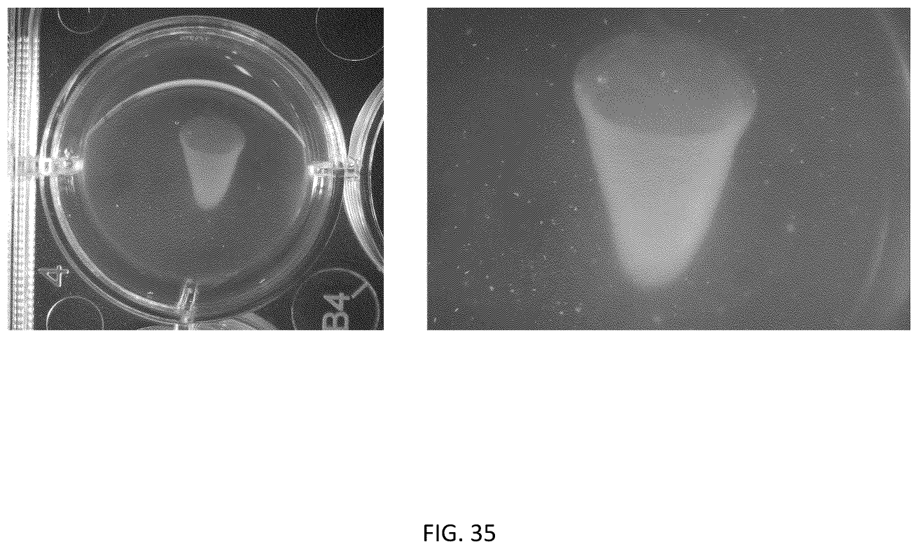

FIG. 35 depicts a 3D ventricle construct bioprinted in TRACE support bath with an iPSC-derived cardiomyocytes laden-collagen bioink.

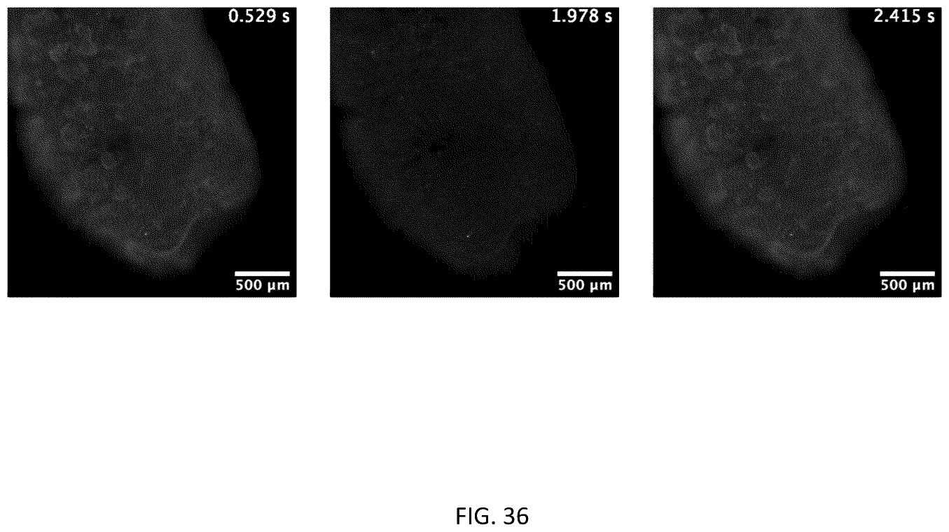

FIG. 36 depicts the calcium signaling of an iPSC-derived cardiomyocytes laden ventricle that was printed in TRACE bath and matured for 21 days.

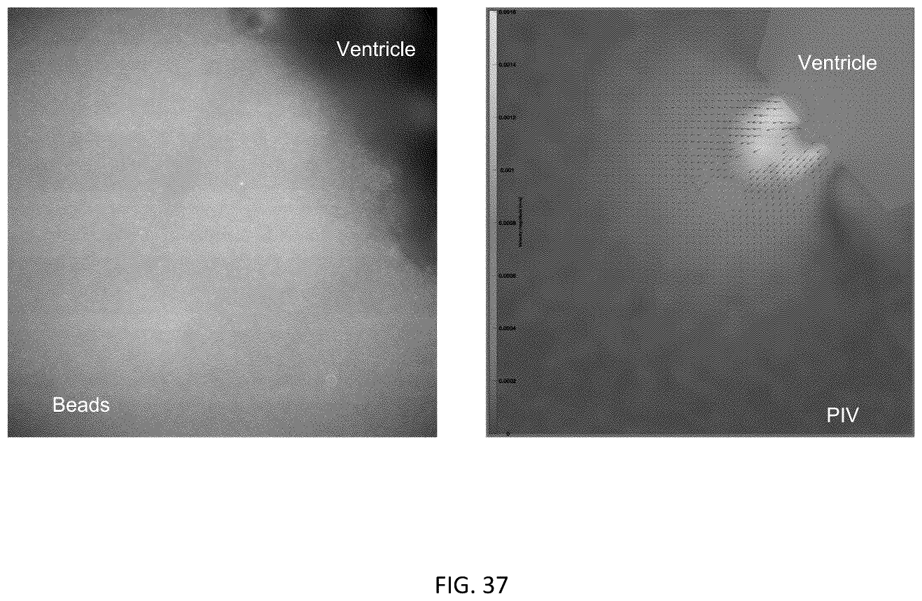

FIG. 37 depicts the fluid pumping function of the 21-day printed cardiac ventricle, with fluid pumping velocity analyzed from a particle image velocimetry (PIV) experiment.

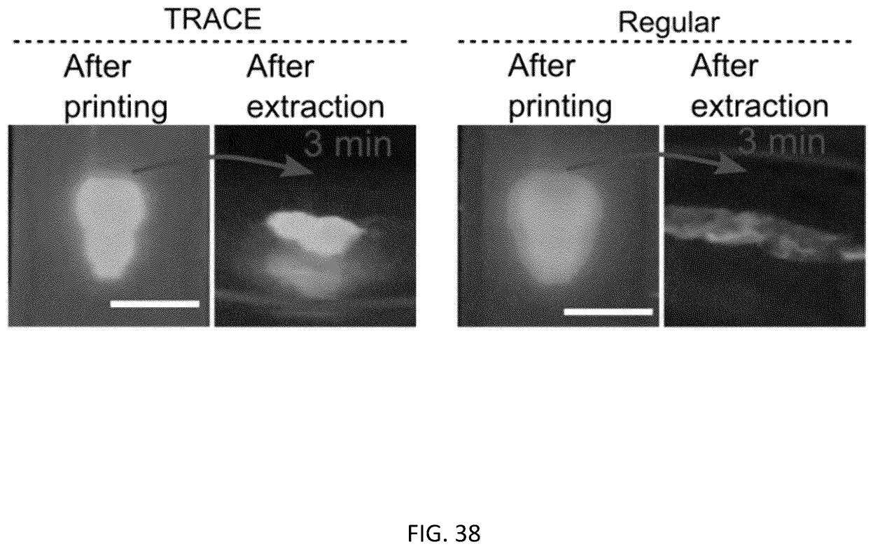

FIG. 38 depicts rapid extraction (3 minutes) of collagen construct printed in TRACE printing bath.

FIG. 39 shows that compared to the unmodified regular agarose slurry bath, TRACE bath induces rapid gelation of low viscosity collagen ink (2 mg/mL, neutralized), to prevent diffusion-induced low-fidelity bioprinting and porous constructs.

FIG. 40 shows that Compared to the unmodified regular agarose slurry bath, TRACE bath induces rapid gelation of low viscosity collagen ink (2 mg/mL, neutralized), to prevent overly incorporating slurry particles and porous constructs.

FIG. 41 Printing tubular structure with collagen composite ink containing collagen bundle.

FIG. 42 is a flowchart depicting an exemplary method of printing PEG solution into a bath filled with collagen solution, termed as “inverted TRACE printing”.

FIG. 43 depicts the inverted TRACE printing method where PEG solution is extruded into a receptacle filled with a neutralized collagen solution to create printed luminal structures.

FIG. 44 depicts the formation of a spiral lumen in a collagen block created by inverted TRACE printing.

FIG. 45 depicts perfusing a spiral lumen printed in a collagen block with a green fluorescent microbeads solution.

FIG. 46 depicts a section of the collagen channel created by the inverted TRACE printing method.

FIG. 47 is a flowchart depicting an exemplary method of increasing the mechanical property of bioprinted tubes through dehydration and crosslinking with genipin.

FIG. 48 depicts dehydration and crosslinking of bioprinted tubes FIG. 49 shows that the mechanically enhanced bioprinted tubes can be easily manipulated by a tweezers operated by hand.

FIG. 50 shows the inner and outer diameter and wall thickness of the mechanically enhanced collagen tube, as well as the and surface topography of both inner and outer surfaces of the tube.

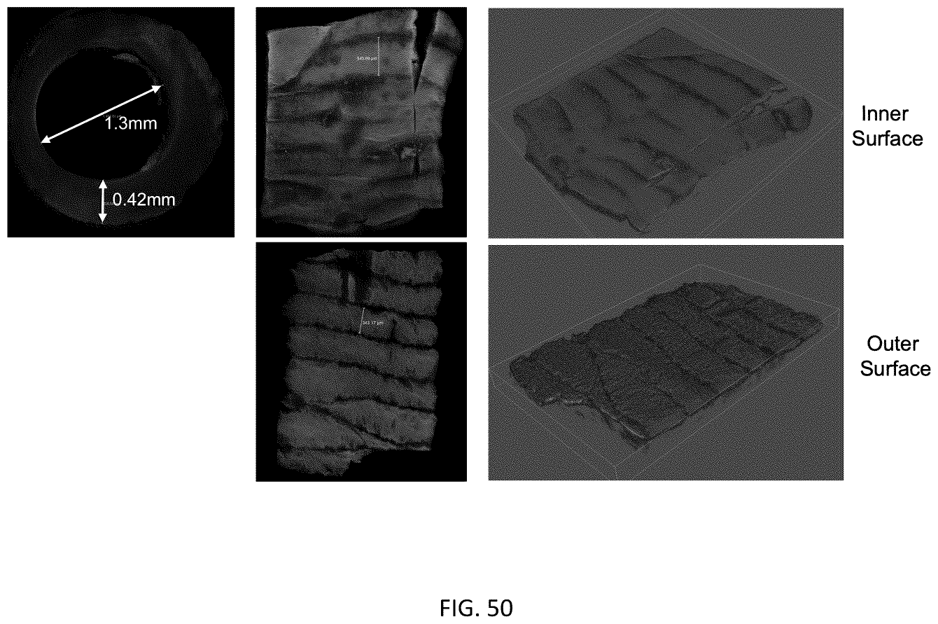

### DETAILED DESCRIPTION

It is to be understood that the figures and descriptions of the present invention have been simplified to illustrate elements that are relevant for a clear understanding of the present invention, while eliminating, for the purpose of clarity many other elements found in the field of bioprinting and tissue engineering. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

### Definitions

It is to be understood that the figures and descriptions of the present invention have been simplified to illustrate elements that are relevant for a clear understanding of the present invention, while eliminating, for the purpose of clarity, many other elements typically found in the art. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined elsewhere, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

The use of “bioprinting” as used herein is interchangeable with “printing” and “extruding” and comprises an additive manufacturing process similar to 3D printing and uses a digital file as a blueprint to print an object layer by layer. However, unlike 3D printing, bioprinters print with cells and biomaterials, creating, in some examples, organ-like structures that let living cells multiply.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6, and any whole and partial increments there between. This applies regardless of the breadth of the range.

### Bioprinting of Collagenous Bioinks

Additive manufacturing (AM) is generally a process in which a three-dimensional (3D) object is manufactured utilizing a computer model of the objects. The basic operation of any AM system consists of slicing a three-dimensional computer model into thin cross sections, translating the result into two-dimensional position data and feeding the data to control equipment which manufacture a three-dimensional structure in a layer-wise manner.

3D bioprinting is an additive manufacturing methodology which uses biomaterials, or biological materials, optionally in combination with chemicals and/or cells, that are printed layer-by-layer with a precise positioning and a tight control of functional components placement to create a 3D structure.

Aspects of the present invention relate to various biomaterials in liquid form (e.g., dispersions) defined as a bioink which can be used for 3D Bioprinting of various constructs. In some embodiments, the bioinks of the present invention may be used in liquid extrusion bioprinting. More particularly, embodiments of the invention include a method of making bioink from collagen material and use of the bioink with and without cells to bioprint various 3D constructs.

Aspects of the present invention relate to a collagenous bioink as contemplated herein. In some embodiments, the bioink is a mixture or solution of materials comprising any form of collagen. In some embodiments, the bioink comprises any of solubilized collagen I, unmodified collagen I, bundled collagen, collagen solutions, neutralized collagen solutions, and acidic collagen solutions. In some embodiments, the bioink comprises collagen solutions with direct cell inclusion. In some embodiments, the bioink comprises uncoated collagen.

In some embodiments, any known collagen may be used in the materials and methods described herein. The collagen may be any collagen known in the art, such as collagen Type 1-29. In some embodiments, the collagen may be a fibrillar collagen such as Types I, II, III, V and XI, which serve as a principal structural component in load-bearing extracellular matrix (ECM). The collagen may be isolated or derived from a natural source or manufactured in any suitable manner. For example, the collagen may be biochemically or synthetically manufactured, produced through genetic engineering, or the like. Collagen may also be purchased from any one of a number of commercial vendors. Collagen may be obtained from any suitable mammalian tissue. For example, collagen may be obtained from tendons, bones, cartilage, skin, or any other suitable organ. In some embodiments, the collagen is obtained from rat tail tendon, porcine or calf skin. In some embodiments, the collagen is sourced from rat tail collagen type 1 (e.g. Corning, 354249). Regardless of the source, the collagen may be purified. The purified collagen may be in any suitable form, such as a powder.

The bioink and/or collagen solution may be neutralized in any suitable manner. For example, the bioink and/or collagen solution may be neutralized by adding a base to the solution. Any suitable base may be used. For example, the base may be sodium hydroxide (NaOH). In some embodiments, the bioink and/or solution is neutralized by adjusting the pH of the solution to a pH of 5 or greater. In some embodiments, the bioink and/or solution may be adjusted to a pH of about 5 to about 10, such as about 5.5 to about 9.5, about 6 to about 9, about 6.5 to about 8.5, or about 6.5 to about 8. In some embodiments, the bioink and/or solution is neutralized by adjusting the pH of the solution to a pH of 7.

The neutralized bioink and/or solution may also be altered in any other suitable manner. For example, a suitable buffer, such as phosphate buffered saline (PBS) or the like, may be added to the solution. In some embodiments, the collagen is neutralized with NaOH and/or adjusted to the desired concentration with PBS.

In some embodiments, the bioink comprises a collagen solution having any suitable concentration of collagen. In some embodiments, the collagen solution comprises collagen at a concentration of about 50 mg/m or less, such as about 30 mg/ml or less, about 25 mg/ml or less, about 20 mg/ml or less, about 15 mg/ml or less, about 10 mg/ml or less, about 8 mg/ml or less, about 6 mg/ml or less, about 4 mg/ml or less, or about 2 mg/ml or less. In some embodiments, the solution comprises a concentration of collagen ranging from about 1 mg/mL to about 20 mg/mL, or about 1 mg/mL to about 10 mg/mL.

In some embodiments, the bioink comprises acetic acid and/or pre-chilled acetic acid. In some embodiments, the bioink comprises NaOH and/or PBS. In some embodiments, the bioink comprises food coloring and/or fluorescent beads. In some embodiments, the bioink comprises physiological materials such as, but not limited to, natural ECM components and/or ECM proteins. In some embodiments, the bioink comprises non-interspaced cells. In some embodiments, the bioink comprises collagen I, ECM proteins, fibrin, basement membrane proteins, Matrigel, Geltrex, collagen IV, laminin, collagen of any type from any species, growth factors, cell culture media, phosphate-buffered saline (PBS), any pH buffering solution, NaOH, any PH neutralizing or modifying solution, glycosaminoglycans, hyaluronic acid, dextran, acid solubilized collagen I solution, neutralized collagen I solution, solution of pre-formed collagen fibers or fiber bundles. In some embodiments, the bioink comprises granular gel particles that create a porous structure.

In some embodiments, the bioink further comprises one or more additives and/or one or more cells. Contemplated additives and/or cells include, but are not limited to, growth factors, neurotrophic factors, cell adhesion molecules, proteins, peptides, small molecules, nucleic acid molecules, cytokines, stem cells, Schwann cells, up-regulators of regeneration-associated genes. In some embodiments, the bioink comprises induced pluripotent stem cells (iPSCs). In some embodiments, the bioink comprises human umbilical vein endothelial cells (HUVECs). In some embodiments, the bioink comprises fluorescently-labeled mesenchymal stem cells, hepatocarcinoma cells, and/or vascular endothelial cells. In some embodiments, the bioink further comprises any of induced pluripotent stem cells, stem cells of any type, endothelial cells, primary cells, cell lines, cancer cells, any mammalian cells, any cell type.

Exemplary growth factors or neurotrophic factors include but are not limited to, glial cell derived neurotrophic factor (GDNF), nerve growth factor (NGF), epidermal growth factor (EGF), vascular endothelial growth factor (VEGF), fibroblast growth factor (FGF), ciliary neurotrophic factor (CNTF), platelet derived growth factor (PDGF), brain derived neurotrophic factor (BDNF), basic fibroblast growth factor (bFGF), neurotrophin 3 (NT-3), and neurotrophin 4 (NT-4), insulin-like growth factor 2 (IGF-2), and the like.

Aspects of the present invention relate to a method for preparing a bioink. In some embodiments, the method comprises the step of mixing stock collagen with acetic acid. In some embodiments, the acetic acid is pre-chilled. In some embodiments, the method comprises neutralizing stock collagen. In some embodiments, the method comprises storing stock collagen in cold conditions. In some embodiments, the collagen is neutralized with NaOH and/or adjusted to the desired concentration with PBS. In some embodiments, the method comprises adding food coloring and/or fluorescent beads to aid in the visualization of the printed construct. In some embodiments, one or more cells and/or additives are mixed with neutralized collagen. In some embodiment, HUVECs and/or iPSCs are mixed with neutralized collagen. In some embodiments, a 6 mg/mL acidic collagen bioink is prepared by diluting stock collagen at a concentration of 8.08 mg/mL with pre-chilled 0.02N acetic acid.

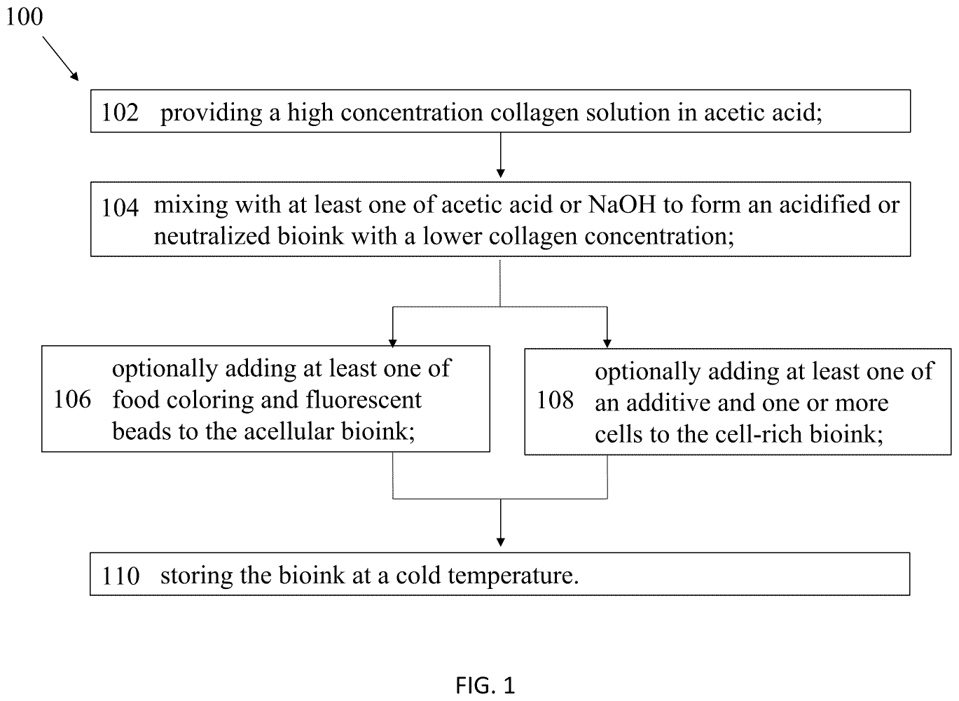

Referring now to FIG. 1, shown is an exemplary method 100 for preparing a bioink comprising the steps of: providing a high concentration collagen solution in acetic acid; mixing with at least one of acetic acid or NaOH to form an acidified or neutralized bioink with a lower collagen concentration; optionally adding at least one of food coloring and fluorescent beads to the acellular bioink; optionally adding at least one of an additive and one or more cells to the cell-rich bioink; storing the collagen solution at a cold temperature.

Aspects of the present invention relate to a support bath for bioprinting any bioink, including for example, the disclosed bioink of the present invention. In some embodiments, the support bath is referred to as a macromolecular support bath, an agarose support bath, or a sacrificial slurry. In some embodiments, the support bath comprises a macromolecular solution and/or mixture that imparts forces on the bioprinted bioink and holds the bioink stationary in the support bath while printing. In some embodiments, the support bath comprises agarose and/or PEG. In some embodiments, the support bath comprises a PEG-slurry. In some embodiments, the support bath is contained within a receptacle. In some embodiments, the receptacle is a glass or plastic cuvette, a glass or plastic petri dish, and/or a glass or plastic well-plate.

In some embodiments, the support bath is a solution and/or mixture of materials comprising any of polyethylene glycol (PEG), PBS, Dextran, a water-soluble polymer, Glycosaminoglycans, Hyaluronan Acid, polysaccharides, agarose, and any other suitable materials containing large molecules. In some embodiments, the macromolecular bath solution comprises PEG that may have a number average molecular weight (Mn) in a range from about 2000 to about 30,000 Da. In some embodiments, the PEG may have a high molecular weight of about 8000 Da. In some embodiments, the support bath comprises high molecular weight (8,000 and 20,000) polyethylene glycol PEG8000 and PEG20000 (Sigma) in 1×PBS at the concentration of 200 mg/mL or 800 mg/mL. In some embodiments, the solution or mixture may have any suitable concentration of materials. For example, from about 10% (w/v) to about 50% (w/v) in water or phosphate buffered saline (PBS), or from about 20% (w/v) to about 40% (w/v). In some embodiments, the solution or mixture may be prepared by dissolving high molecular weight (˜8000 Da) polyethylene glycol PEG8000 (Sigma) in 1×PBS at the concentration of 200 mg/mL. In some embodiments, the support bath comprises any of agarose, agarose slurry, gelatin, gelatin slurry, PBS, water, and water-soluble polymer polyethylene glycol (PEG) of molecular weight 8000 Da, PEG of molecular weight 20000 Da, PEG of any molecular weight between 8000 and 20000 Da, PEG of any molecular weight between 0-8000 Da, PEG of any molecular weight, methylcellulose, dextran, and any viscosity modifying reagent.

Aspects of the present invention relate to a method for preparing a support bath solution. In some embodiments, the method comprises the step of mixing agarose in boiling PBS to form an agarose slurry. In some embodiments, the method comprises cooling the agarose slurry from about 85° C. to about 20° C. In some embodiments, the agarose slurry is autoclaved prior to the cooling step. In some embodiments, the method comprises stirring and/or mixing the agarose slurry during the cooling process. In some embodiments, the method comprises stirring the agarose slurry with a magnetic bar. In some embodiments, the magnetic bar is set to a speed of 700 rpm. In some embodiments, the method comprises mixing 3 parts of the agarose slurry with 1 part of PEG 8000 solution in PBS. In some embodiments, the mixing is performed by pumping the materials back and forth in one or more syringes. In some embodiments, the agarose slurry is boiled and sterilized in an autoclave.

In some embodiments, the support bath solution may be stored at room temperature. In some embodiments, the support bath solution enables macromolecular crowding (MMC). In some embodiments, the support bath solution enables rapid gelation of acidic bioinks. In some embodiments, the support bath solution enables rapid gelation of non-acidic bioinks and/or neutralized bioinks. In some embodiments, the support bath solution enables printing of bioinks comprising a low-concentration of collagen.

In some embodiments, the PEG solution may be sterilized with any method known to one skilled in the art including but not limited to being sterilized by a 0.45 μm syringe filter.

In some embodiments, the support bath solution may be stored at any temperature known to one skilled in the art. In some embodiments, the support bath solution may be stored in room temperature. In some embodiments, the support bath solution may be stored in cold temperatures.

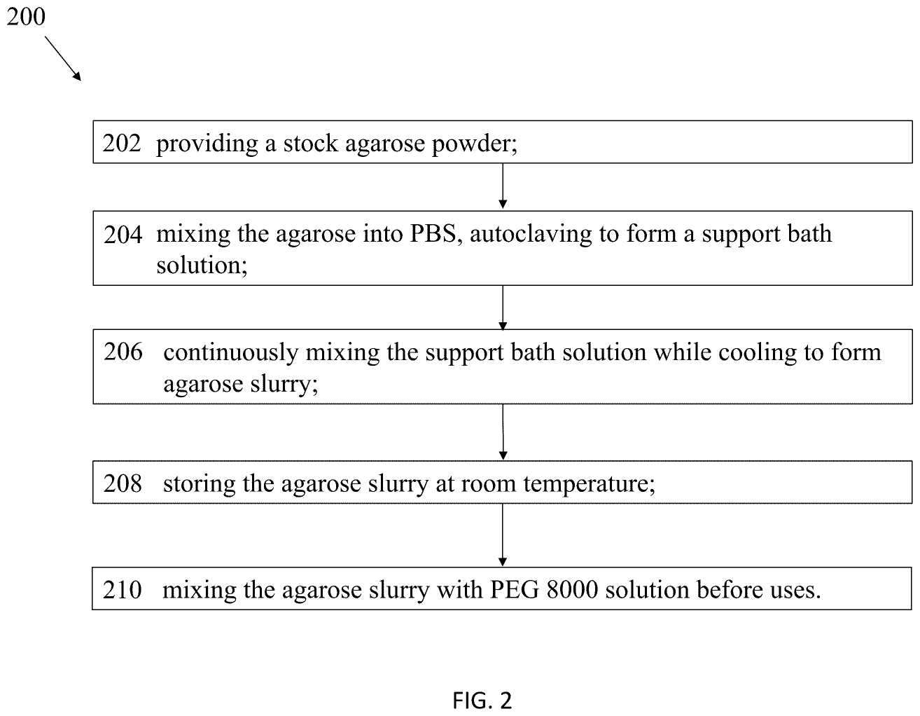

Referring now to FIG. 2, shown is an exemplary method 200 for forming a support bath solution, comprising the steps of providing a stock agarose powder; mixing the agarose into PBS, autoclaving to form a support bath solution; continuously mixing the support bath solution while cooling to form agarose slurry; storing the agarose slurry at room temperature; mixing the agarose slurry with PEG 8000 solution before use. In some embodiments, method 200 may further comprise adding one or more materials to the support bath before, during, or after any of the preparation steps listed above.

The disclosed methods are based on accelerating the gelation of collagen solutions to instantaneous speeds via macromolecular crowding, allowing rapid and versatile patterning of both cell-free and cell-rich collagen-based bioinks. In some embodiments, the method allows for printing on single-digit micron scale (e.g. <10 μm resolution). In some embodiments, the method produces collagen filaments with a width less than 5 μm. In some embodiments, the methods allow for printing of constructs with non-interspaced cells between the printed collagen layers. In some embodiments, the methods further comprises programming the printed material (e.g. programming iPSCs). In some embodiments, the methods include seeding or coating the constructions and/or biological structures with one or more cells after bioprinting.

Aspects of the present invention provide a method for bioprinting crowded collagen constructs, and articles, such as engineered tissue and/or biological structures comprising the crowded collagen constructs. In some embodiments, the bioprinting method of the present invention is able to generate large-scaled tissue constructs from ground-up. In some embodiments, the method of present invention enables a novel means for rapid bioprinting using natural Extracellular matrix (ECM) proteins. In some embodiments, the bioprinting method of present invention is able to generate various geometries, including but not limited to long, macroscopic tissue strips, tubes, domes, solid or hollow shapes, vessel networks of various topologies and free-form shapes. In some embodiments, the method of present invention allows fabrication of collagen constructs in any shape including but not limited to tubes, gourds, cones, scaffolds, microbundles, mesoscale strips, and mesoscale disks. In some embodiments, the method of the present invention provides a novel macromolecular support bath (also referred to as a slurry bath, sacrificial bath, or support medium) wherein the bioink solution is extruded from a printing tip or nozzle that is submerged in the support bath generating at least one 3D construct.

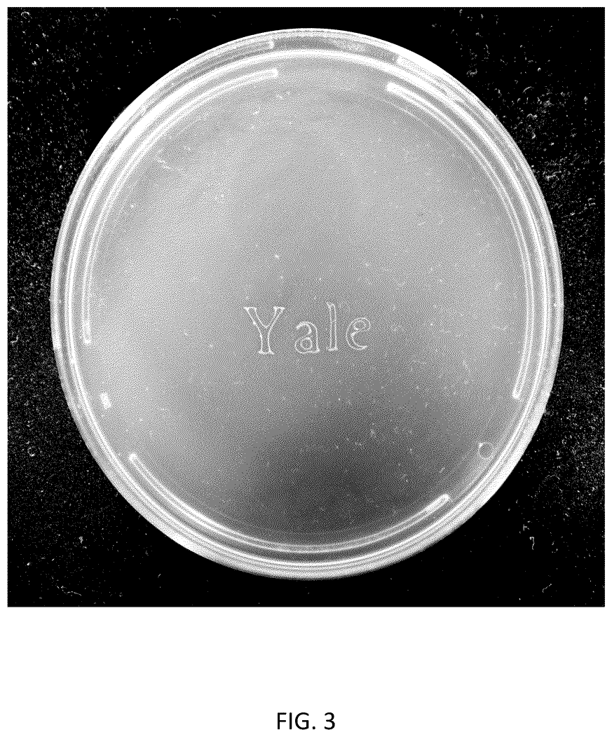

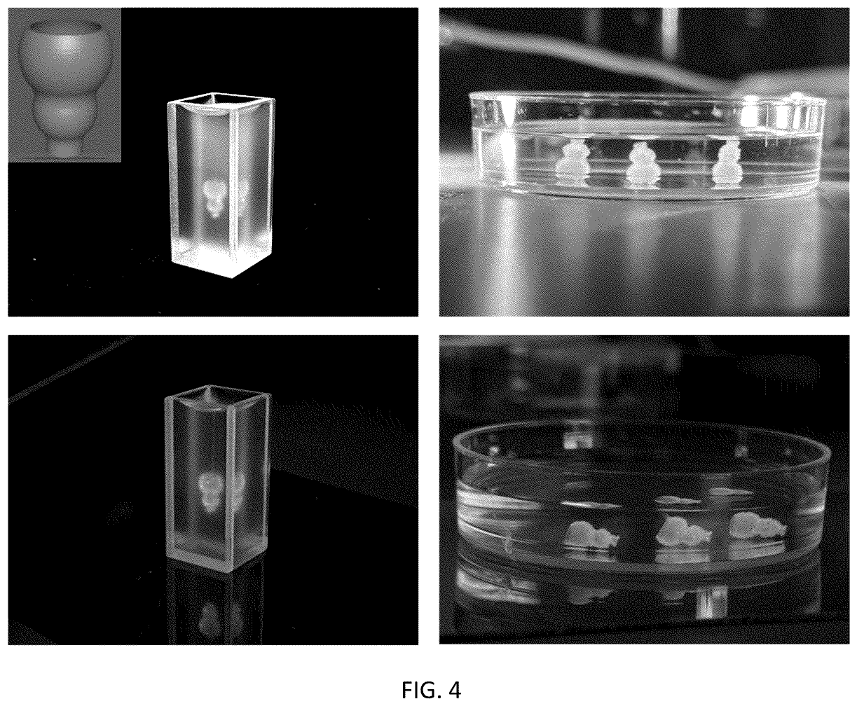

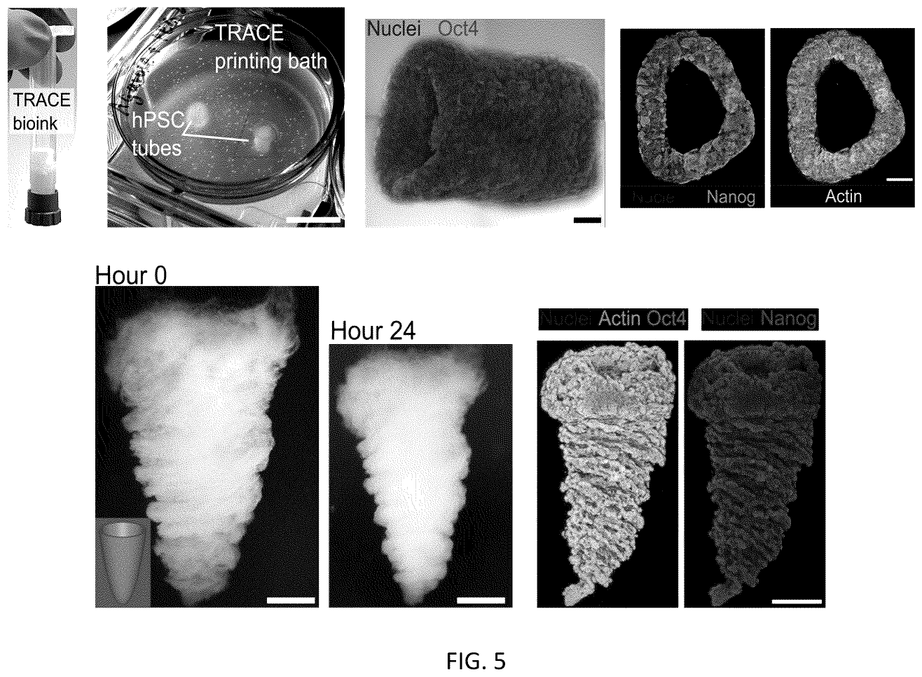

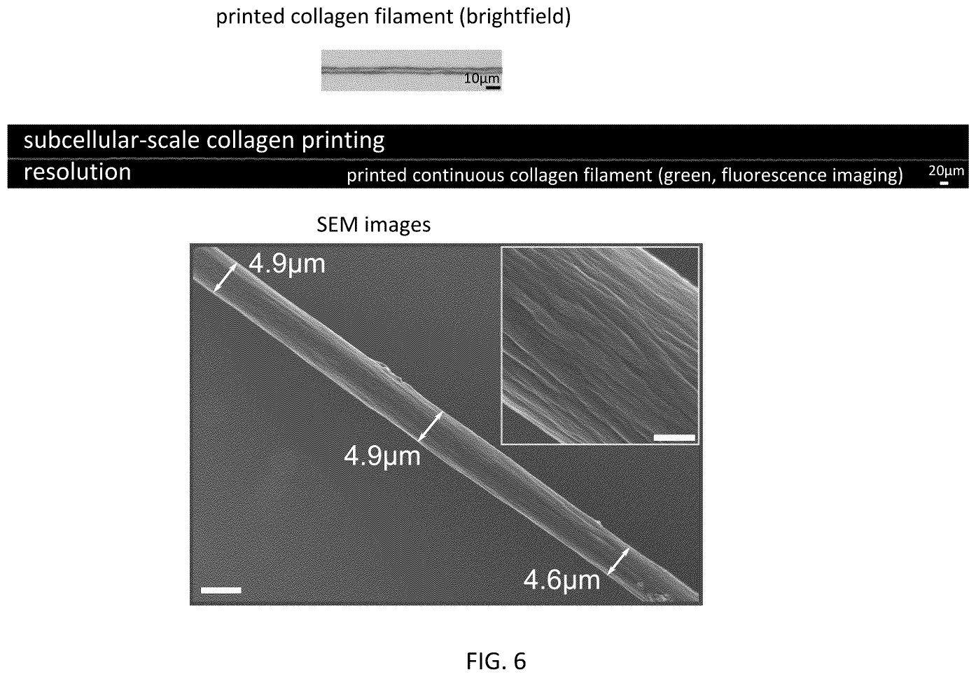

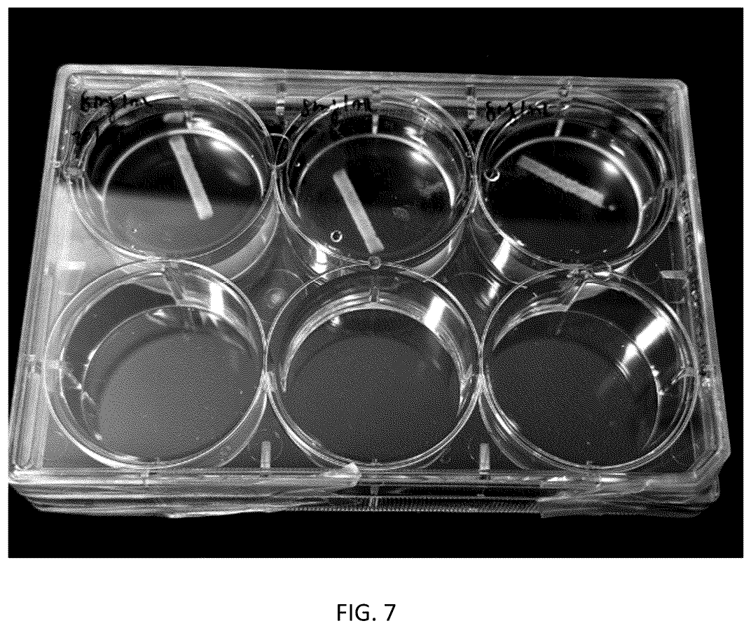

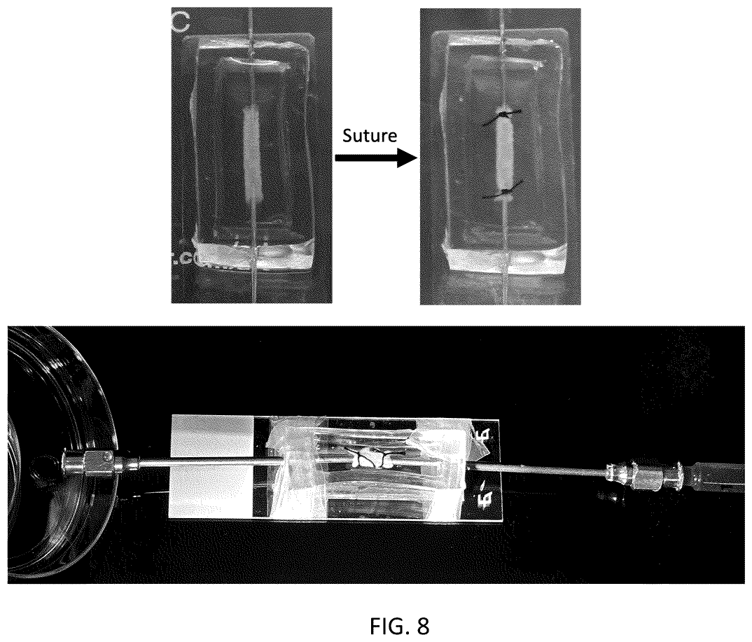

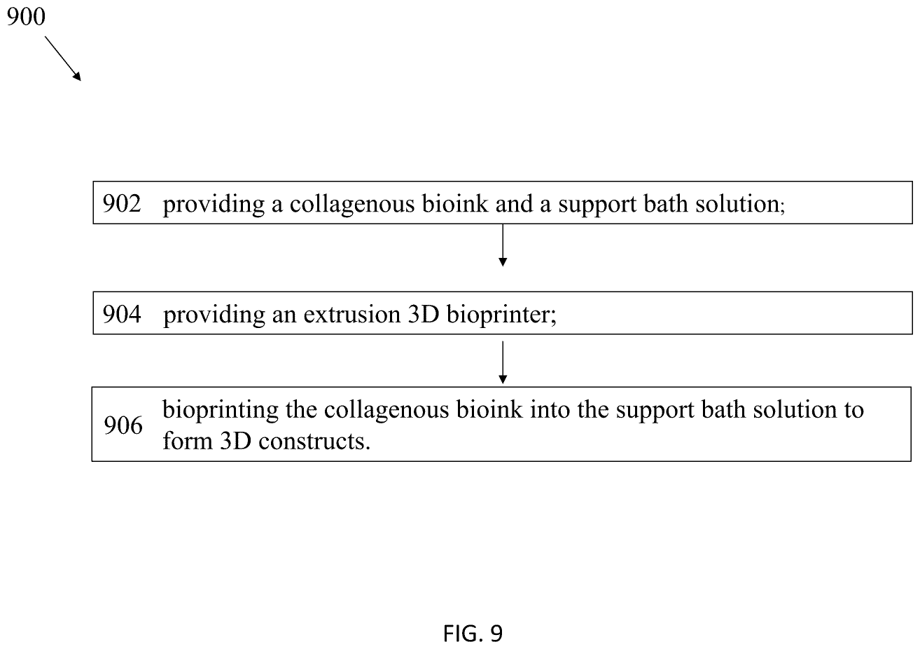

Referring now to FIG. 3 through FIG. 8, shown are various 3D constructs bioprinted with the disclosed bioink and bioprinting methods. In some embodiments, the bioink may be bioprinted into a free-form design (FIG. 3). In some embodiments, the bioink may be bioprinted into a gourd design (FIG. 4). In some embodiments, the bioink may be bioprinted into an iPSC-laden tube (FIG. 5). In some embodiments, the bioink may be bioprinted into a continuous collagen filament (FIG. 6). In some embodiments, the bioink may be bioprinted into vascular grafts and/or collagen vessels having variable lengths and diameters (FIG. 7). In some embodiments, the bioprinted 3D structures may be sutured and perfused, mimicking vascular grafting (FIG. 8)

The bioink and support bath produced by the methods described herein may be used to engineer any suitable tissue and/or biological structure. For example, bioink and support bath may be used to engineer soft tissue structures, cartilaginous structure, connective tissue, vascular tissue, bone tissue, and the like. The bioink and support bath may be used to engineer soft tissue of the trachea, epiglottis, vocal cords, and the like. The bioink and support bath may be used to engineer articular cartilage, nasal cartilage, tarsal plates, tracheal rings, thyroid cartilage, arytenoid cartilage. The bioink and support bath may be used to engineer vascular grafts and components thereof. The bioink and support bath may be used to engineer sheets for topical applications or for repair of organs such as livers, kidneys, and pancreas. The bioink and support bath may be used to engineer bone, dental structures, joints, cartilage, skeletal muscle, smooth muscle, cardiac muscle, tendons, menisci, ligaments, blood vessels, stents, heart valves, corneas, car drums, nerve guides, tissue patches or sealants, a filler for missing tissues, skin, or the like. The bioink and support bath may be used to engineer intestinal tissue, or the like. In some embodiments, the bioink and support bath may produce hollow and/or luminal structures. In some embodiments, the biological structures are used for in vitro studies.

Aspects of the present invention relate to a method for 3D bioprinting any disclosed bioink. In some embodiments, the method comprises the step of providing a pneumatic 3D bioprinter with a temperature-controlled print head and/or nozzle. In some embodiments, the print head and/or nozzle are sterilized in an autoclave before use. In some embodiments, the print head is set to a temperature ranging from 5-15° C., with a preferred temperature of about 8° C. In some embodiments, the method comprises bioprinting with nozzles ranging from 50 gauge to 10 gauge in size. In some embodiments, the method comprises bioprinting at a speed ranging between 1 mm/s and 50 mm/s. In some embodiments, the method comprises extruding one or more bioinks at an extrusion pressure ranging between 1 kPa and 50 kPa. In some embodiments, the method comprises extruding acellular bioink at about 8 kPa, and cell-laden bioink at about 20 kPa. In some embodiments, the method comprises loading the bioinks into pre-chilled cartridges, and storing the cartridges in a cold environment until use. In some embodiments, the cartridge is sterilized in an autoclave before loading. In some embodiments, the method comprises providing a bioprint chamber having a built-in UV cycle and HEPA filter. In some embodiments, the bioprinted construct is washed with PBS. In some embodiments, the bioprinted construct is transferred to a culture media in a humid incubator at 37° C. with 5% CO2 for future use.

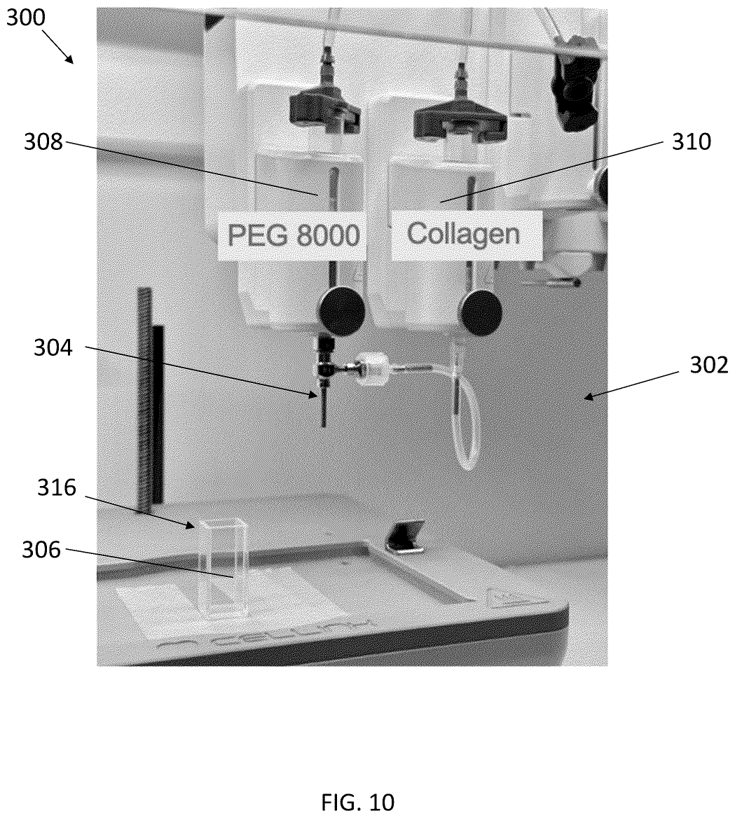

Referring now to FIG. 9, shown is an exemplary method 900 for bioprinting a bioink comprising the steps of: providing a bioink and/or collagen solution and a support bath solution; providing an extrusion 3D bioprinter; and bioprinting the bioink via a submerged bioprinting nozzle or tip into a support bath to form 3D constructs. In some embodiments, the method further comprises the steps of seeding the biological structure with one or more cells after the extracting and washing steps; dehydrating the biological structure; crosslinking the biological structure with one or more crosslinking agents; crosslinking the biological structure with genipin; conditioning the biological structure with mechanical conditioning; and culturing the biological structure in a bioreactor.

In some embodiments, the concentration of the support bath materials, such as PEG, is tuned to tune the gelation or solidification speed of the printed bioink. In some embodiments, the printed layers are merged by overfilling each layer with excess or slightly excess bioink material. In some embodiments, the printing is performed at different extrusion rate or nozzle translation speeds. In some embodiments, the resolution of the printed feature is altered by changing the translational speed of the nozzle during printing. In some embodiments, the resolution of the printed feature is altered by changing the extrusion rate of the bioink from the nozzle.

In some embodiments, the resolution of the printed feature is altered by changing the concentration of support bath components. In some embodiments, the resolution of the printed feature is altered by changing the diameter of the nozzle opening. In some embodiments, the resolution of the printed feature is altered by modifying one or more of the following: translational speed of the nozzle during printing, extrusion rate of the bioink during printing, nozzle diameter size, support bath components, bioink components.

In some embodiments, the support bath solution and the bioink is inverted (i.e. support bath solution material used as the bioink and bioink material used as support bath solution) to enable the printing of bath solution material from the printer nozzle into a support bath of bioink material. In some embodiments, the support bath solution is a bioink material such as collagen I (with or without cells included) and the solution extruded from the printer nozzle is PEG.

Aspects of the present invention relate to coaxial bioprinting of one or more bioinks with one or more support baths.

In some embodiments, the coaxial bioprinting is performed with a pulled glass nozzle (inner diameter) and coaxially aligned with and a gauge 25 needle.

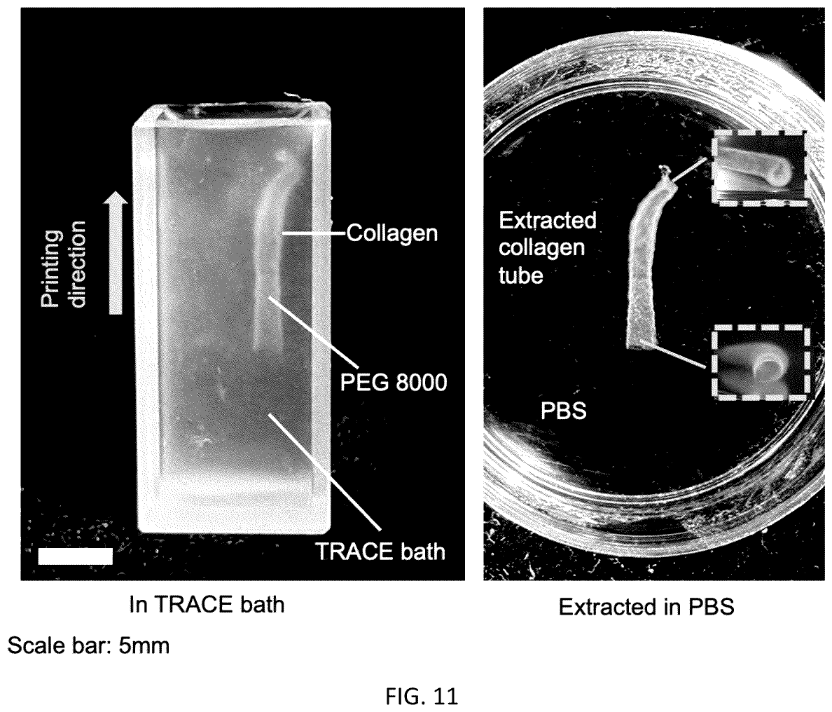

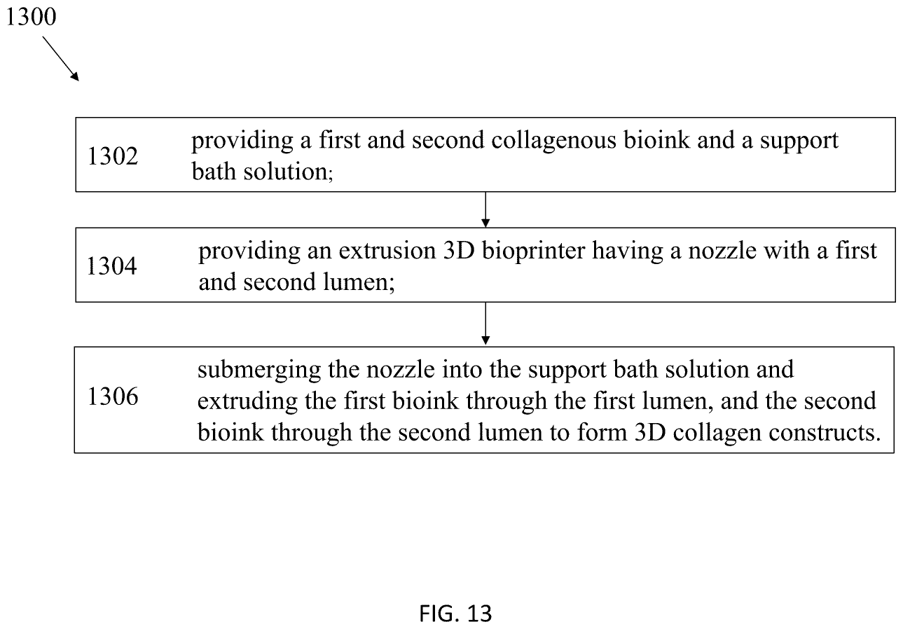

Referring now to FIGS. 10 and 12, shown is an exemplary bioprinting system 300. In some embodiments, system 300 comprises a bioprinter 302 comprising one or more reservoirs for holding any disclosed bioink of the present invention, wherein each reservoir is in fluid connection with one or more nozzles 304. System 300 further comprises a support bath 306 wherein nozzle 304 is at least partially submerged to bioprint any structure (e.g. a biological structure). In some embodiments, bioprinter 302 comprises a first reservoir 308, and a second reservoir 310, and one or more conduits connected thereto. In some embodiments, the reservoirs are in direct fluid connection with nozzle 304, and in other embodiments, the reservoirs first fluidly connect to a conduit, and then nozzle 304 thereafter. In some embodiments, nozzle 304 comprises a first lumen 312 and a second lumen 314, wherein first reservoir 308 fluidly connects with first lumen 312, and second reservoir 310 fluidly connects with second lumen 314. In some embodiments, first lumen 312 and second lumen 314 are coaxially arranged within nozzle 304. In some embodiments, system 300 further comprises a printing receptacle 316 wherein support bath 306 may be contained and/or held. In some embodiments, printing receptacle 316 comprises a glass or plastic cuvette, a petri dish, and/or a well plate. In some embodiments, support bath 306 comprises a mixture of agarose and PEG. In some embodiments, support bath 306 comprises any support bath solution of the present invention as disclosed.

In some embodiments, nozzle 304 is configured for a first bioink to extrude from first lumen 312, and a second bioink to extrude from the second lumen 314.

In some embodiments, system 300 comprises a nozzle 304 comprising an first lumen 312 configured to print PEG, and a second lumen 314 configured to print bovine collagen solution. In some embodiments, the PEG is PEG 8000 (800 mg/mL) and the bovine collagen solution is Telocol-6 (6 mg/mL acidic type 1 bovine collagen). In some embodiments, system 300 is configured to bioprint any disclosed bioink of the present invention. Further contemplated embodiments involve bioprinting any disclosed bioink from the first reservoir, and a support bath solution from the second reservoir.

In some embodiments, system 300 comprises a nozzle 304 configured with a first lumen 112 extruding PEG, a second lumen 114 extruding a collagenous bioink, and a support printing bath. In some embodiments, nozzle 114 is moved upwards along axis 320 as the bioprint progresses.

In some embodiments, nozzle 304 has a first lumen 312 having an outer diameter ranging between 5 gauge and 20 gauge, and an inner diameter ranging between 5 gauge and 20 gauge. In some embodiments, nozzle 304 has a second lumen 314 having an outer diameter ranging between 5 and 20 gauge, and an inner diameter ranging between 5 and 20 gauge.

In some embodiments, system 300 comprises a second lumen 314 extrusion pressure ranging between 1 kPa and 20 kPa, a first lumen 312 extrusion pressure ranging between 1 kPa and 20 kPa, and a printing speed ranging from 1 mm/s to 20 mm/s. For example, in some embodiments, the system 300 comprises a first lumen 312 extrusion pressure of 4 kPa, a second lumen 314 extrusion pressure of 17 kPa, and a printing speed of 6 mm/s.

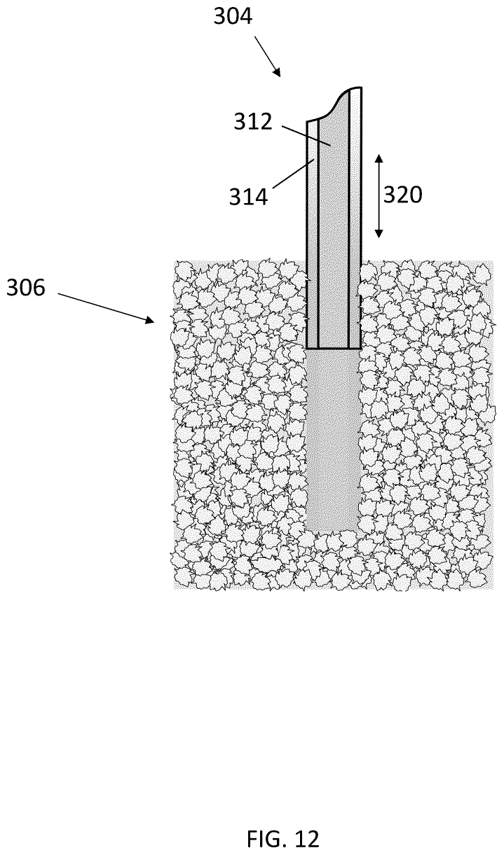

Referring now to FIG. 11, shown is an exemplary coaxial bioprinted tube. In some embodiments, various tube geometry (e.g. diameter and wall thickness) are dependent on fluid properties, nozzle size, extrusion pressure, and print speed. In some embodiments, the printed tube has a length of 1.2 cm. In some embodiments, the bioprinting method comprises printing both bioinks vertically upwards in a macromolecular support bath at the same speed. In some embodiments, the method comprises waiting a period of time (e.g. at least 1 minute) until the collagen bioink has solidified. In some embodiments, the method comprises extracting the bioprinted structure in PBS, and washing/dissolving the inner PEG bioink out/away.

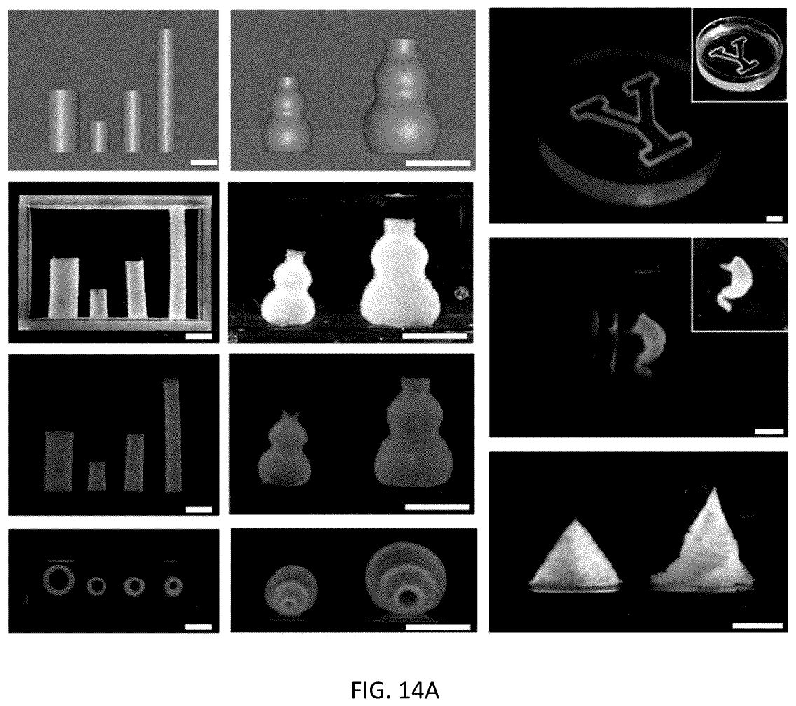

Referring now to FIG. 13, shown is an exemplary method 1300 for coaxial bioprinting one or more bioink comprising the steps of: providing a first and second bioink and a support bath solution; providing an extrusion 3D bioprinter having a coaxial nozzle comprising a first and second lumen; submerging the coaxial nozzle into the support bath; and extruding the first bioink through the first lumen, and the second bioink through the second lumen into the support bath solution to form 3D collagen constructs and/or biological structures. In some embodiments, the method comprises simultaneous extrusion of the one or more bioinks. In some embodiments, the method comprises intermittently extruding one or more bioinks.

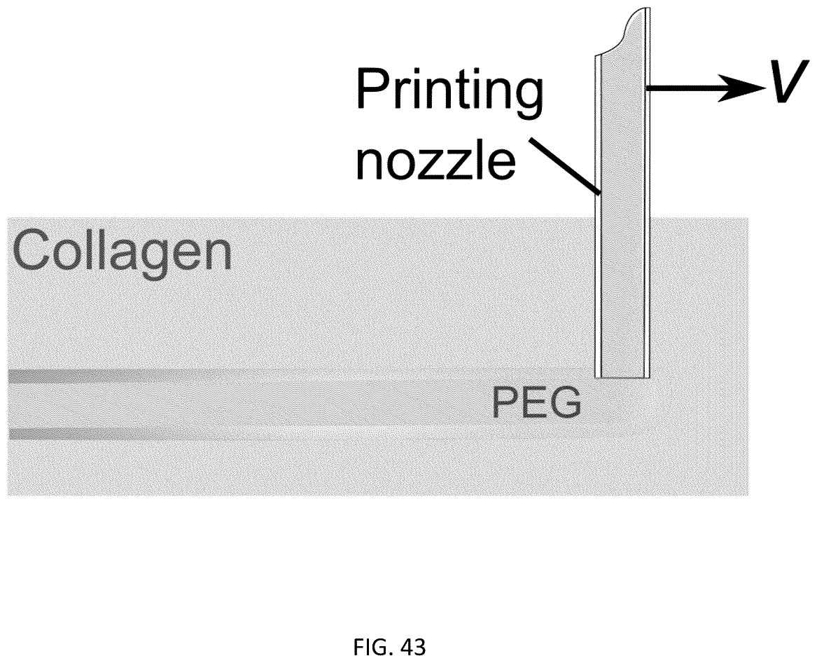

Referring now to FIG. 42, shown is an exemplary method 4200 of printing PEG solution into a bath filled with collagen solution, termed as “inverted TRACE printing”, comprising the steps of providing a neutralized collagenous solution and a PEG 8000 solution, providing a 3D bioprinter with an extrusion nozzle, and bioprinting the PEG 8000 into the collagen solution directly to form 3D collagen based lumen around the printed PEG solution.

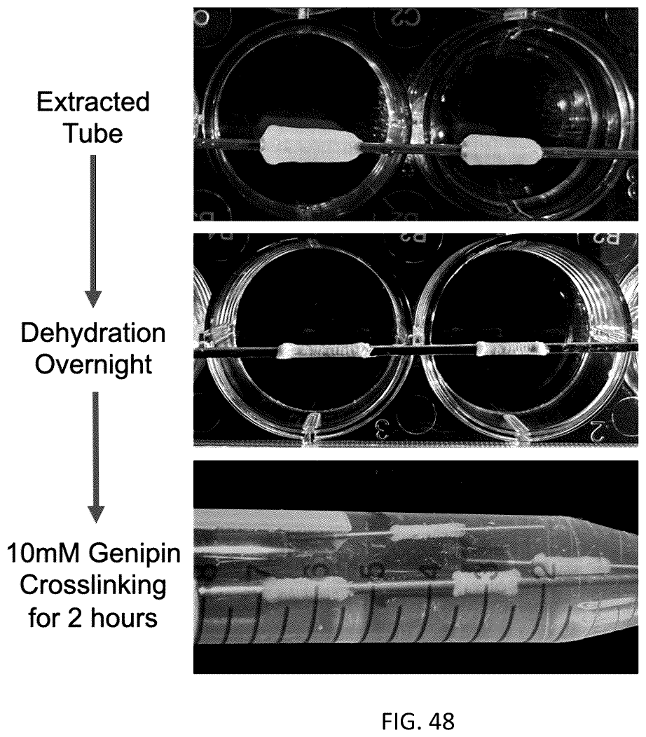

Referring now to FIG. 47, shown is an exemplary method 4700 of increasing the mechanical property of bioprinted tubes through dehydration and crosslinking with genipin, comprising the steps of providing a bioprinted collagenous tube, a stainless steel mandrel, providing a genipin solution, inserting the stainless steel mandrel through the lumen of collagenous tube extracted from the support bath, dehydrate overnight to remove 99% of the water, submerging the dehydrated tube into genipin solution to crosslink for 2 hours, then wash with PBS.

### EXPERIMENTAL EXAMPLES

The invention is further described in detail by reference to the following experimental examples. These examples are provided for purposes of illustration only and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art may, using the preceding description and the following illustrative examples, make and utilize the compounds of the present invention and practice the claimed methods. The following working examples therefore specifically point out exemplary embodiments of the present invention and are not to be construed as limiting in any way the remainder of the disclosure.

### Example 1: Versatile Bioprinting of Collagenous Bioinks

Tissues in the body are composed of complex 3D patterns of cells and the extracellular matrix (ECM). These patterns are difficult to recapitulate with conventional tissue culture techniques (e.g. embedding cells in a hydrogel). Bioprinting offers promise toward the generation of in vitro tissues with unparalleled geometric realism for (patho)physiological modeling and regenerative medicine. Accurate 3D positional control and an appropriate bioink “curing” mechanism enable many tissue architectures to be fabricated, including tubes, domes, solid or hollow shapes, and vessel networks of various topologies. Extrusion bioprinting, in which ink is extruded from a nozzle, is a common bioprinting solution owing to its flexibility and ease of adaptability with existing commercial 3D printers.

A grand challenge in bioprinting is the choice and development of the right bioink. Common bioinks include alginate and gelatin methacryloyl (GelMa), which offer excellent printability (easily extrudable and subsequently controllably and rapidly gelled). While these bioinks are demonstrated to maintain cell viability (an initial assessment of biocompatibility), they are non-physiological materials, and demonstration of complex physiological functions of printed tissues using these bioinks is limited. Physiological materials, i.e. natural ECM components, are ideal for promoting physiological bioactivity, but they are not easily printable due to challenges in precisely controlling their gelation after extrusion. For example, solubilized collagen I, a prominent ECM component in the body used for many 3D tissue culture studies, typically requires a duration of tens of minutes to gel, which disrupts patterning accuracy and fidelity due to diffusion and sedimentation (e.g. of cells) during the gelation period after extrusion.

One prominent method for bioprinting collagen is known as FRESH (Free-form Reversible Embedding of Suspended Hydrogels), in which a slurry support bath is used to maintain 3D positional accuracy of extruded bioinks. This method successfully bioprinted acid solubilized collagen I as the bioink, but at very high concentrations (typically 24 mg/mL). A key working mechanism of this method is the rapid gelation of high concentration acidic collagen solutions upon neutralization in a neutralized support bath. The acidity in the collagen solution is required to maintain its liquid form before extrusion (so that it is extrudable), and the high collagen concentration is required to enable fast gelation upon extrusion (gelation speed is concentration dependent)—these requirements enable the printability of collagen I using the FRESH method. However, this mechanism limits flexibility and possible applications, as the acidity of the ink reduces cell viability and poses a challenge for bioprinting cell-laden collagen solutions as the bioink, and the high concentration is limited to tissues where such concentrations are applicable or desired. Typical collagen concentrations in in vitro studies that promote cell activities such as cell spreading and migration are ˜ 1 to 4 mg/mL, where pore size and ECM stiffness are among important biophysical determinants of cell behaviors.

Herein, disclosed is a novel, highly versatile bioprinting method utilizing unmodified collagen I as the primary bioink. In some embodiments, the disclosed method applies macromolecular crowding to rapidly accelerate collagen gelation to instantaneous speeds, enabling the printability of a wide range of collagen concentrations, the printability of neutralized or acidic collagen solutions, and direct cell inclusion into the bioink. In some examples, the disclosed method is termed Tunable Rapid Assembly of Collagenous Elements (TRACE). Disclosed in this example is the development of this method and key demonstrative applications that are not currently possible with other techniques.

Disclosed is the development of a novel bioprinting method (TRACE) that enables versatile, direct writing of collagen I as the bioink. Developed were techniques for bioprinting collagen I of a wide range of concentrations (low and high), from 1 mg/mL to 10+ mg/mL (higher is easier to bioprint). Low concentration unmodified collagen is currently impractical for bioprinting due to long gelation times. The key parameters were determined (including nozzle speed, extrusion rate, interlayer connectivity, degree of molecular crowding, support bath content) that control printing results (resolution, delamination issues, accuracy of printed structure, allowable degree of complexity).

In order to push and understand the physical limits of extrusion bioprinting resolution, a method for liquid-liquid extrusion bioprinting of collagen I ultra-fine fibers was developed. The novel method pushes the spatial limits of bioprintable collagen to single-digit micron scales (the currently published limit is approximately 20 μm). During the development, computational modeling was applied to understand the parameter space and the determinants for generating ultra-high resolution features.

During development, demonstrative cell-laden tissues were bioprinted. Cells were incorporated directly into the collagen I bioink for direct writing of cell-rich tissues, eliminating the requirement of coating cells after printing or interspacing cells between printed collagen layers. Further, densely packed induced pluripotent stem cell (iPSC)-based tissues were bioprinted, and tissue pluripotency and programmability of the printed material was investigated.

Novel innovations surrounding the disclosed bioprinting method include: versatile collagen tunability—wide concentration ranges, inclusion of mixed materials (bundles), cell-laden inks—neutralized collagen enables cells to be directly mixed into the pre-extruded ink, eliminating the requirement of interspacing cells between printed collagen layers or coating printed collagen with cells after printing, rapid ink solidification enables macro-geometries to be printed within minutes (disclosed is the fastest known extrusion collagen printing method using unmodified natural ECM and no artificial materials), pushing the limits of resolution (disclosed is the highest known resolution extrusion bioprinting of collagen), printing collagen bundles—printed geometries are composed of collagen that is in bundled form (collagen is in natural form, not amorphous collagen networks), ability to print hybrid materials with bundles inside collagen network (further disclosed is a multiphase collagen ink), and has the ability to incorporate other ECM proteins into the printed collagen, as other ECM can bind to collagen.

The disclosed method establishes major advances in the extrusion bioprinting of tissues based on natural and unmodified extracellular matrix proteins (particularly collagen I), including both cell-free and cell-laden tissues with user-designable structures. Juxtaposition between current state-of-the-art capabilities and key innovations from the disclosed method is shown in below in Table 1.

TABLE 1
Current vs Novel Capabilities

| | Novel Enabling Capabilities with the Disclosed |
|---|---|
| Current Capabilities and Limitations | Methods |
| 1. Bioinks are typically based on non- | 1. Major advancements in the versatility and |
| physiological materials, such as GeIMA or | capabilities of bioprinting with unmodified |
| Alginate (owing to their printability and | collagen I, the most prominent ECM protein that |
| tunability), but they have limited bioactivity | can promote physiologic bioactivity. |
| with unknown physiological implications. | |
| 2. Bioprinting of unmodified collagen I remains | 2. Bioprinting unmodified collagen I solutions |
| limited, typically restricted to acidic collagen | of any concentration, spanning typical working |
| solutions of high concentration (e.g. via the | ranges from high to low (down to 1-2 mg/mL), |
| FRESH method). | both acidic and neutralized. |
| 3. Bioprinting cell-laden collagen I bioinks | 3. Bioprinting cell-laden collagen I solutions as |
| remains unfeasible, owing to a) the slow | the direct bioink, eliminating the requirement of |
| gelation time of low concentration neutralized | coating/seeding printed structures with cells |
| collagen I and b) the highly acidic environment | after printing or interspacing cells between |
| required for high concentration collagen I | printed collagen layers. Features: |
| bioinks (in order to remain liquid before | a) Rapid acceleration of collagen I gelation |
| extrusion). | kinetics for ultra-fast extrusion bioprinting, |
| Generating cell-laden tissues typically requires | facilitating collagen printability and the printing |
| coating/seeding cells onto pre-printed collagen | of macroscopic structures within minutes. |
| structures or interspacing cells between printed | b) Applicable to both acidic and pre-neutralized |
| collagen layers (rather than direct writing cell- | collagen solutions, enabling cell compatibility |
| laden collagen I bioink). | within neutralized pre-extruded ink. |
| 4. Limited printing resolution (20 μm is the | 4. Ultra-high printing resolution limit, achieving |
| highest demonstrated for extrusion bioprinting, | down to single-digit micrometer scale, along |
| via the FRESH method). | with development of guiding physical |
| | principles. |
| 5. Inclusion of granular gel particles that renders | 5. Rapid gelation of collagen prevents ink |
| porous structure. | diffusion and the over-incorporation of granular |
| | particles. |

### Example 2: Bioprinting Via Instant Collagen Gelation

Controllable assembly of cells and tissues has the potential for generating improved models for studying organ-specific development and disease. It can also produce functional tissues for regenerative medicine. The body's natural cell scaffolding material is the extracellular matrix, composed largely of collagen I. However, challenges in precisely controlling collagen for patterning limit its applicability as a primary source material or bioink for user-definable tissue engineering and printing. Disclosed herein is a set of biopatterning methods, termed Tunable Rapid Assembly of Collagenous Elements (TRACE), that enables instant gelation and patterning of collagen I solutions. The disclosed methods are based on accelerating the gelation of collagen solutions to instantaneous speeds via macromolecular crowding, allowing rapid and versatile patterning of both cell-free and cell-rich collagen-based bioinks. Several notable applications are demonstrated, including organoid engineering and free-form 3D bioprinting. Further demonstrated is high resolution patterning, achieving below 5 μm feature size for extrusion-based collagen filament printing. The disclosed methods and findings enable broader and more versatile applications for collagen-based biofabrication.

### Bioprinting Applications

Enhanced 3D bioprinting was demonstrated via instant collagen gelation. A sacrificial slurry support bath was utilized (composed of agarose) similar to previous work (Lee, A. et al. 3D bioprinting of collagen to rebuild components of the human heart. Science 365, 482-487 (2019).) PEG was premixed into the agarose slurry to create a PEG-slurry bath to enable MMC (macromolecular crowding). The disclosed method induces instant gelation of collagen upon contact with the bath, including low concentration and neutralized collagen solutions. This enables the use of cell-free and cell-rich collagen solutions as bioinks. Cells remain viable in the neutralized bioinks, and relatively low collagen concentration (2-5 mg/mL) is permissible to cell migration and self-organization.

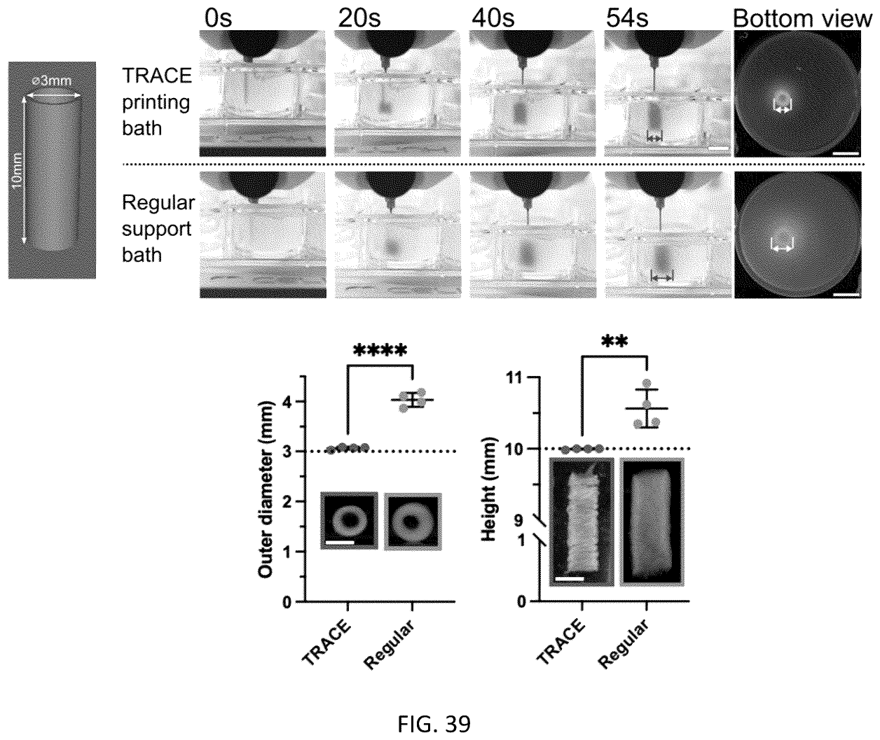

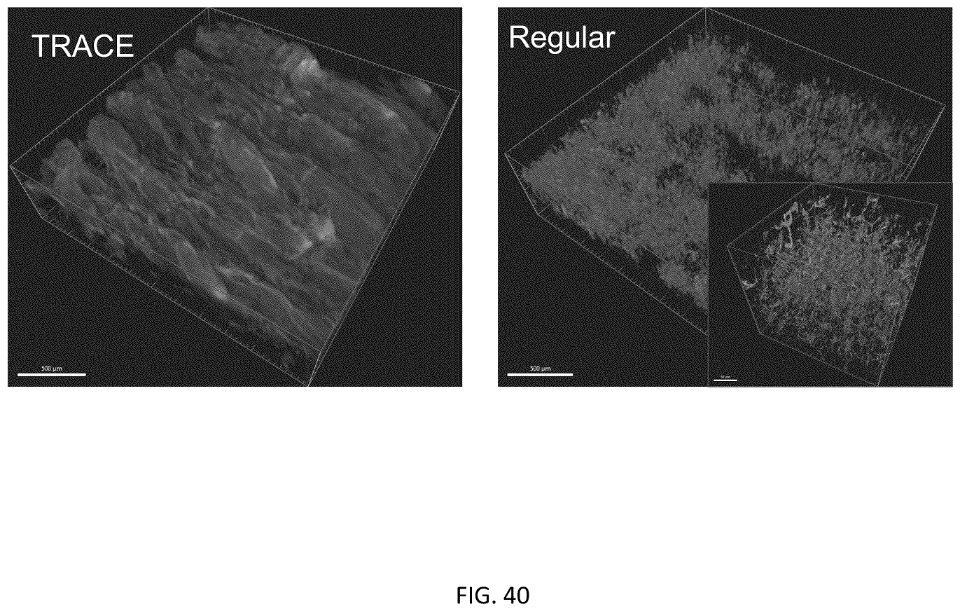

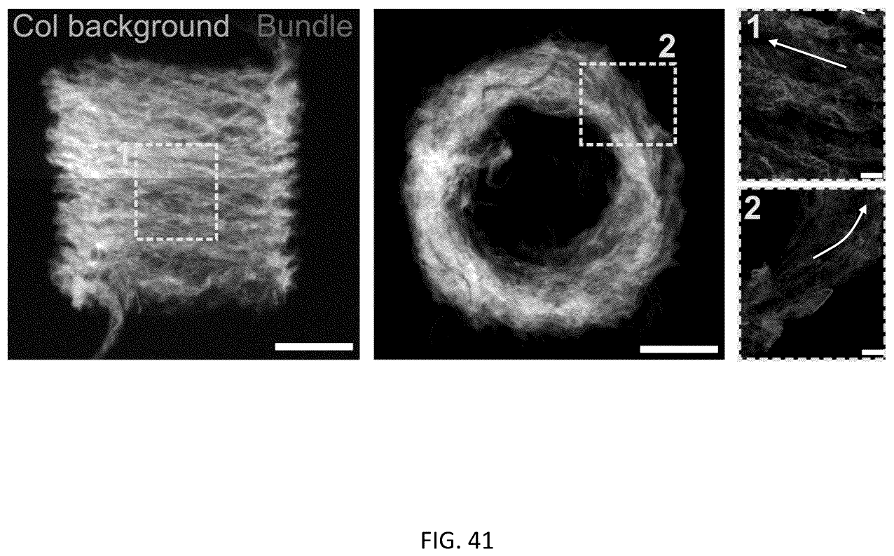

A commercial bioprinter was utilized to extrude user-defined patterns. Various cell-free 3D collagen scaffolds were printed, including tubes, hollow ellipsoids, cones, and curves. With PEG in the support bath, the collagen ink prints more rapidly (FIG. 38), limiting diffusion, after extrusion. Without PEG, the collagen sediments/diffuses during the slower gelation process, resulting in reduced printing accuracy (FIG. 39) and over incorporation of agarose slurry (FIG. 40). The impact of PEG is most prominent for low concentration collagen solutions, which typically require longer to gel compared to high concentration collagen solutions. Both neutralized and non-neutralized (acidic) collagen solutions instantly gel and can be printed in the disclosed PEG-slurry baths. After printing, the patterns can be released from the bath. The patterns maintain their form after release, enabling downstream tissue engineering applications.

Bioprinting of cell-laden collagen bioinks was also demonstrated. Macroscopic patterns were generated, including those demonstrated in the cell-free examples above, with high, tissue-relevant cell densities. Cells were directly embedded in the bioinks and subsequent bioprinted patterns, enabling the use of a single bioink solution for bioprinting cell-rich collagen tissues (rather than requiring interspacing of collagen-free and cell-rich regions with separate bioinks). 3D bioprinting of both endothelial and liver tissues was demonstrated. Cells remain highly viable. Endothelial tissues form junctions and mimic vascular tissues.

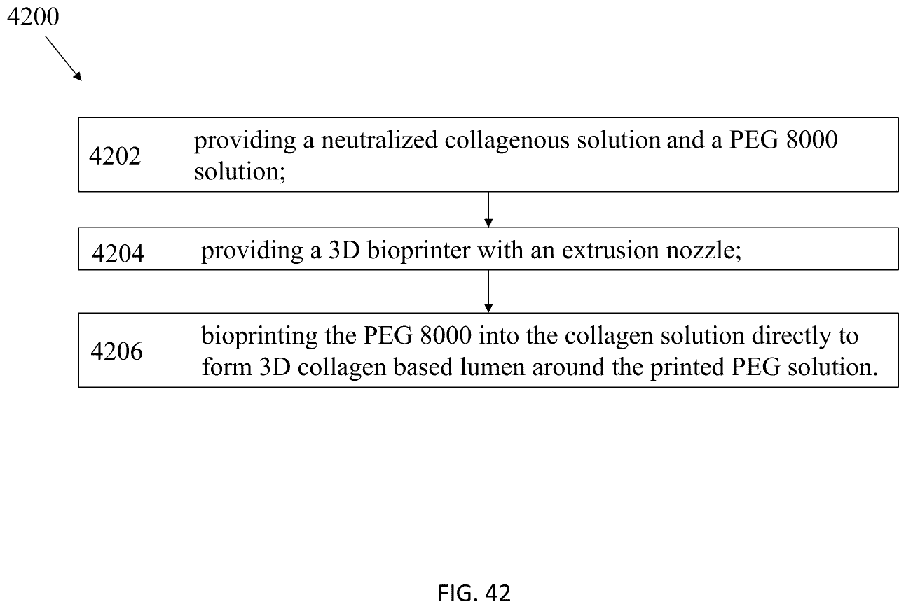

Bioprinting of composite collagen bioinks were also demonstrated. By mixing pre-formed microscopic collagen bundles in a neutralized collagen, a collagen bioink that consists of microscale collagen architecture was developed. The bioink can be bioprinted into macroscopic 3D construct as such a tube (FIG. 41).

### Pushing the Limits of Bioprinting Resolution

The limits of bioprinting resolution were explored using the disclosed methods. Here a PEG bath was utilized without slurry to induce instant gelation. Lines of collagen were printed in this bath under various settings to characterize limits and governing parameters. The results show that nozzle diameter and print speed are key determinants of bioprinting resolution. Using nozzles with relatively small diameters (˜100 μm) and a high print speed, high resolution printing was achieved, generating collagen filaments with a width of less than 5 μm. Long, continuous filaments were extruded, reaching macroscopic length scales, while maintaining macromolecular scale widths. For comparison, reconstituted and in vivo collagen matrices are typically composed of interconnected collagen fibers with micrometer scale widths. Thus, the disclosed method enables the bioprinting of macroscopic tissue patterns with macromolecularly resolved features.

The materials and methods employed as well as the results of these experiments are now described.

### Rapid Gelation of Collagen I in the Macromolecular Bath

The crowding bath was prepared by dissolving high molecular weight (8,000 and 20,000) polyethylene glycol PEG8000 and PEG20000 (Sigma) in 1×PBS at the concentration of 200 mg/mL or 800 mg/mL. The solution can be stored at room temperature. For tissue culture applications, the PEG8000 bath was sterilized by a 0.45 μm syringe filter. Rat tail collagen type I (Corning, 354249) was neutralized (pH=7) with NaOH and adjusted to the desired concentrations with PBS. When delivered into the PEG8000 bath, a collagen solution rapidly polymerized and formed various shapes depending on the delivering methods.

### Patterning of Ultrathin Collagen Microfilament

An open-source extrusion-based 3D printer (Lulzbot) was used to pattern the microscale fibers. A pulled glass nozzle (inner diameter) was coaxially connected to the Gauge 25 needle and tightly sealed with Parafilm. Acetic collagen (8-10 mg/mL) was delivered into the fine glass nozzle via the interior needle at designed extrusion speeds. For the microfiber patterning, patterns were designed with SolidWorks (Dassault Systèmes) and converted the dxf files to G-Codes with a free online G-Code generator (https://optlasers.com/cnc-software/g-code-generator). The G-Code was then modified to be compatible with the 3D printer, print filaments at high-speed ranging 100-1000 mm/min, and contain material “charging points” at low speeds of 70 mm/min or 0.3 mm/min. The G-Codes for different patterns with designated extrusion speed and printing speed were included in the supplementary information.

TRACE Support Bath Generation with Agarose-PEG Mixture

Biocompatible inert hydrogel, agarose, was utilized to create a supportive slurry following a protocol modified from a previous study (Moxon, S. R. et al. Suspended Manufacture of Biological Structures. Advanced Materials 29, 1605594 (2017).)

The agarose slurry was prepared by dissolving 0.7% (w/w) agarose in boiling PBS−/− in a 50 mL Ball Mason Jar, followed by gradual cooling from 85° C. to 20° C. on heat plate while stirring with a magnetic bar at 700 rpm. TRACE support bath was created by thoroughly mixing 3 parts of the resulting agarose slurry with 1 part of 800 mg/mL PEG 8000 solution in PBS−/− to obtain a final PEG concentration of 200 mg/mL. Mixing was achieved by pumping the two materials in syringes back and forth through a 90-degree syringe connector for 100 times. For cell laden collagen bioprinting, the agarose solution was autoclaved prior to cooling and PEG 8000 was filtered through a 0.45 mm filter for sterilization. The mixing accessories were also autoclaved.

TRACE Bioink Preparation with Low Concentration of Type I Collagen and High Cell Density

Three bioinks were employed in TRACE 3D printing studies. To evaluate the printability of TRACE methods with low concentration collagen, acellular bioink was prepared in two concentrations. The 6 mg/mL acidic collagen was prepared by diluting the stock collagen at a concentration of 8.08 mg/mL with pre-chilled 0.02N acetic acid. The 2 mg/mL collagen was first neutralized and stored in cold condition. Food color and fluorescent beads were incorporated into the acellular bioink to aid the visualization of the printed construct. To prepare the bioink of cell laden collagen, neutralized collagen at a concentration of 2 mg/mL was made following the previously described method. HUVECs and iPSCs was then mixed with neutralized collagen to produce a final concentration of 4×10⁶ and 4×10⁷ cells/mL, respectively.

### TRACE Printing

Extrusion based bioprinting was performed using a commercialized pneumatic bioprinter (Cellink BioX6) with the temperature-controlled print head installed. All digital models were designed in SolidWorks and exported as stereolithography (.stl) files. The files were sliced and printed using DNA studio 3.0 (CELLINK), with a layer height of 0.2 mm. 25-gauge nozzles with 0.5 or 1 inch in length (0.5 or 1 inch) were utilized to print at speeds of 10 mm/s or 5 mm/s, with extrusion pressures of 8 kPa for acellular printing and 20 kPa for cell laden printing. Prior to printing, a container with sufficient size to accommodate the printed construct was filled with TRACE support bath and secured to the printing bed. The temperature-controlled print head was set to 8° C. Each ink was loaded into a pre-chilled cartridge (BD 3component 3 mL syringe) and then stored on ice until use. To ensure sterile conditions during cell laden collagen printing, the printer chamber was subjected to a built-in UV cycle, and the clean chamber fan equipped with HEPA filter was activated. The cartridge and nozzle used for printing were sterilized by autoclaving. After the printing was completed, the printed structures were secured in the TRACE bath for at least 3 min, and then extracted carefully from the bath by a spatula or directly pouring. The printed construct was then thoroughly rinsed in a PBS−/− bath to remove any excess TRACE bath. Subsequently, the printed constructed was transferred to desired culture media and cultured in a humid incubator at 37° C. with 5% CO2 for future applications.

### Example 3: Novel Biopatterned Microtissue Elucidate Cell-ECM Contractile Mechanics

The disclosed method biopatterned collagen-based microtissues with tunable geometry and mechanical properties to observe tissue assembly and contractile mechanics. It was demonstrated that cells can remodel and compact collagen into denser, mechanically distinct states. The differences between endothelial and mesenchymal cell-ECM interactions that correlate with cell motility and contractility were shown. Vascular tissues proliferate and bud when seeded on collagen scaffolds. Collagen microtissues can model dynamic and disease-relevant ECM-tissue interactions such as ECM remodeling, angiogenesis, and fibrosis. Characterizing these interactions also informs biomaterial design in tissue engineering.

The extracellular matrix (ECM) is a complex network of fibrillar proteins such as collagen that surrounds cells and provides mechanical and chemical cues. The ECM directs cell morphology, movement, adhesion, and identity while maintaining tissue homeostasis.

Cell-ECM interactions are of interest in tissue engineering and regenerative medicine, as engineered biomaterials must transmit appropriate signals for tissue organization. However, while cell-scale responses have been well-characterized, bulk tissue interactions are poorly defined despite their relevance to disease progression.

Engineered biomaterials aim to mimic tissue microenvironments. In this study, novel patterned collagen microtissues as a lens to study tissue dynamics within an engineered ECM was highlighted. The microtissues demonstrate tissue behavior in the context of different organs and cell types.

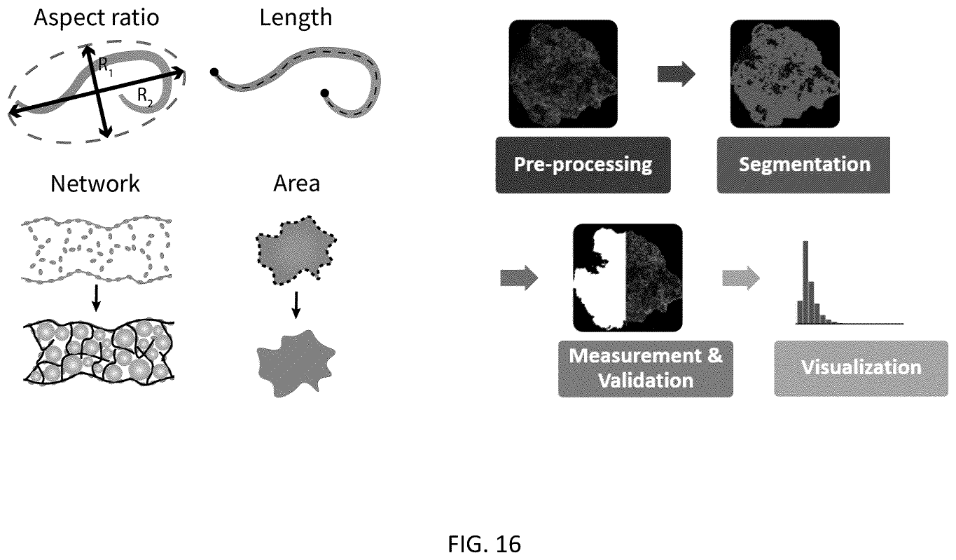

FIG. 15 shows H&E staining of fibrotic regions in patient liver sections with hepatocellular carcinoma.

The materials and methods employed as well as the results of these experiments are now described.

### Collagen Microtissue Patterning & Collagen Characterization

Novel methods for collagen biopatterning in various geometries and mechanical properties were developed. Fluorescently-tagged collagen was patterned without cells and imaged via confocal microscopy for pore size, thickness, and intensity.

### Microtissue Culture & Imaging

Fluorescently-labeled mesenchymal stem cells, hepatocarcinoma cells, and vascular endothelial cells were added into collagen constructs of strip and bundle geometries. Tissues were cultured for 5-7 days and imaged daily using confocal microscopy.

### Imaging, Measurements, & Analysis Pipeline

Tissue construct parameters such as length and surface area were measured using customized ImageJ macros. BoneJ plugin was used to quantify network pore sizes.

### Physical Tunability of Patterned Collagen

When compared to conventional hydrogels—patterned collagen constructs are denser. The density and pore size are tunable by changing concentration. Rheometry shows that the disclosed constructs have a higher modulus than conventional gels. It was found that using the disclosed method, collagen can be patterned into tunable microbundles. The disclosed method achieved sizes that are ideal for cell scaffolding (10-15 μm).

### Contractile Tissue Compact Collagen Scaffolds

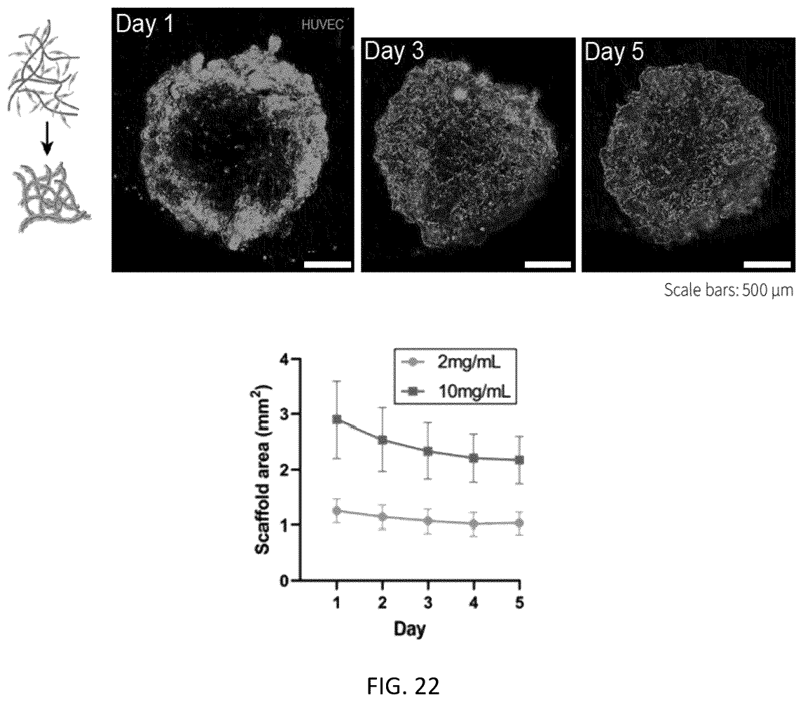

Endothelial cells (HUVEC) and mesenchymal stem cells (MSC) were patterned into collagen strips to compare contractile activity. Across 5 days, it was found that MSC strips shrink more than HUVEC strips, perhaps due to increased contractility. It was postulated that increased collagen density may provide mechanical resistance against tissue compaction. 10 mg/ml microbundles (magenta) with MSCs (green) were incorporated, and decreased shrinking was observed (See FIG. 21).

### Collagen-Guided Self-Assembly of Microvasculature

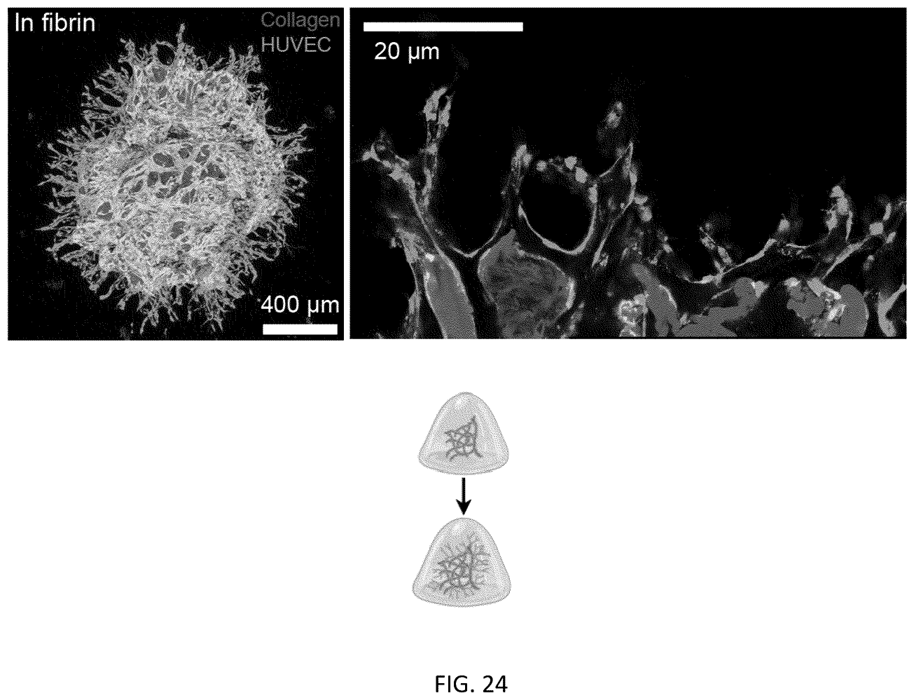

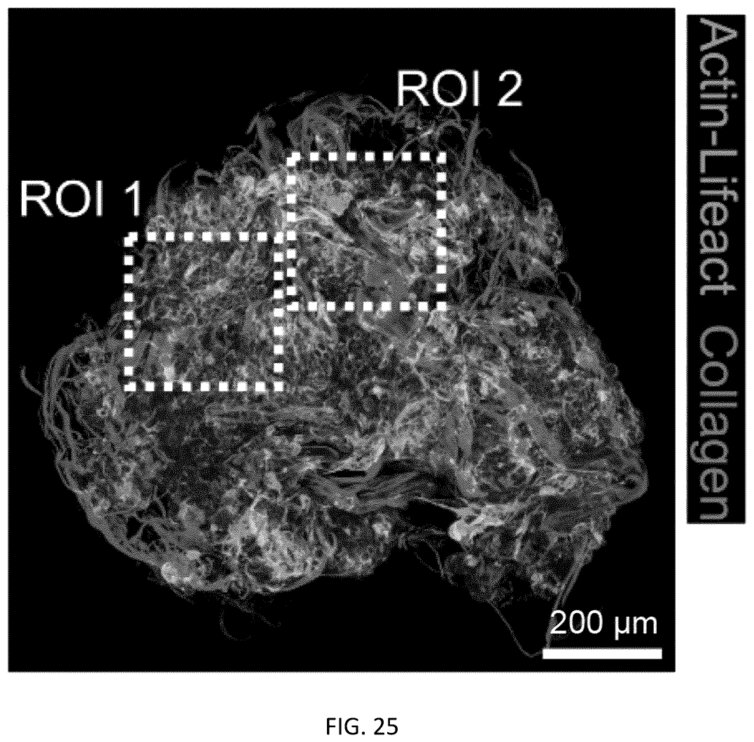

HUVECs were incorporated with collagen microbundles to create microvasculature. HUVECs expressed VE-cadherin (red) and F-actin (yellow), (See FIG. 23) indicating endothelial contact integrity. Bundles topologically guided cell migration into internal regions and were compacted by cells. Collagen compaction was density-dependent, indicating cells responded to substrate stiffness. It was postulated that collagen microbundles support angiogenesis of microvasculature. 7-day microvasculature were embedded into fibrin gel domes. Long-term branching outgrowth (green) was observed, (See FIG. 24) that followed initial microbundle architecture (red).

### Microbundles Mimic Fibrotic Deposits

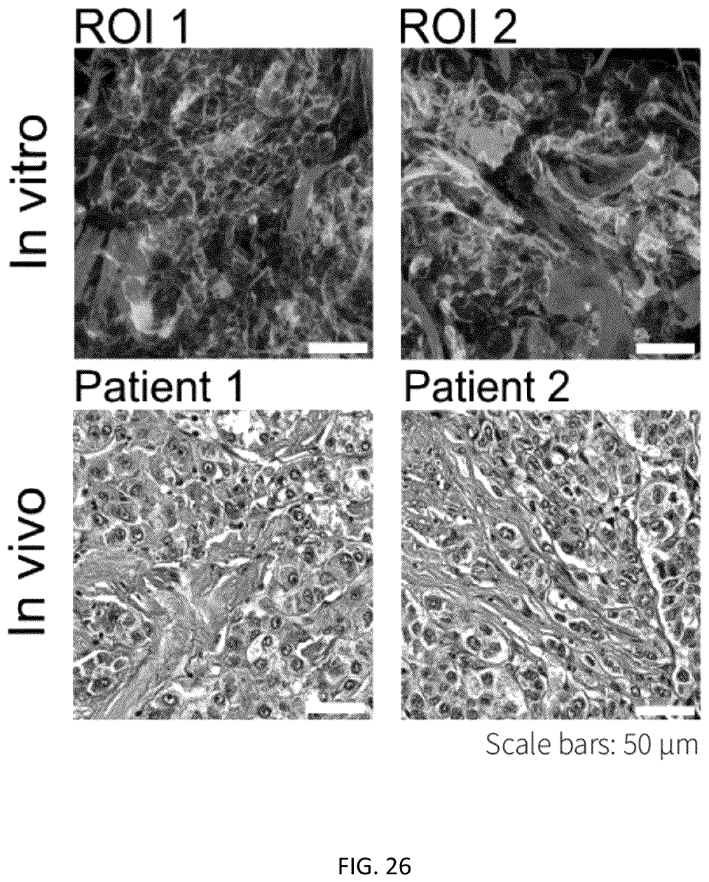

It was postulated that patterned collagen can recapitulate fibrosis. Hepatocarcinoma cells (green) were mixed with collagen microbundles (magenta) to create tumor spheroids (See FIG. 25). The microbundles mimicked dense fibrotic deposits that compress boundary cells. It was shown that the resultant spheroids with microbundles cover larger, more variable surface area than those without.

### Discussions and Future Directions

The disclosed methods and results demonstrated collagen-biopatterned microtissues to study cell-ECM interactions within different types of tissues.

Compared to conventionally gelled collagen, patterned collagen better recapitulates the scale, density, and architecture of in vivo collagen. Mechanical properties are easily tunable via collagen concentration.

Collagen-biopatterned microtissues are viable for long-term culture and display functional activity. Cells are responsive to tuned properties and display behaviors such as migration and contractility. Compaction of surrounding ECM has implications for diseases based on aberrant mechanosignaling or ECM cues.

### Example 4: Coaxial Bioprinting

The disclosed method also provides examples for coaxial bioprinting using at least two bioinks.

Referring now to FIG. 10, shown is an exemplary coaxial bioprinting setup and method. In some embodiments, the exemplary coaxial bioprinting setup comprises a Cellink Biox6 printer. In some embodiments, the coaxial bioprinting setup comprises a printing receptacle. In some embodiments, the printing receptacle is a glass or plastic cuvette. In some embodiments, the exemplary coaxial bioprinting setup comprises a support bath (TRACE bath), comprising agarose granular bath mixed with 200 mg/mL PEG 8000. In some embodiments, the coaxial bioprinting setup comprises a coaxial nozzle having an inner nozzle configured to print PEG 8000 (800 mg/mL), and an outer nozzle configured to print collagen (acidic type 1 collagen). In some embodiments, the coaxial nozzle has an outer diameter of 14 gauge, and an inner diameter of 18 gauge. In some embodiments, the bioprinting parameters comprise an outer nozzle pressure of 17 kPa, an inner nozzle pressure of 4 kPa, and a printing speed of 6 mm/s.

Referring now to FIG. 11, shown is an exemplary coaxial printed tube. In some embodiments, various tube geometry (e.g. diameter and wall thickness) are dependent on fluid properties, nozzle size, extrusion pressure, and print speed. In some embodiments, the printed tube has a length of 1.2 cm. In some embodiments, the bioprinting method comprises printing both bioinks vertically upwards in the TRACE bath at the same speed. In some embodiments, the method comprises waiting until the collagen bioink has solidified. In some embodiments, the method comprises extracting the printed structure in PBS, and washing/dissolving the inner PEG bioink out/away.

Referring now to FIG. 12, depicted is an exemplary schematic for extrusion coaxial bioprinting. In some embodiments, the coaxial bioprinting setup comprises a coaxial nozzle having an inner nozzle with PEG, an outer nozzle with collagen bioink, and a TRACE printing bath. In some embodiments, the coaxial print nozzle is moved upwards as the print progresses.

### Example 5: Inverted TRACE Bioprinting

The disclosed method also provides examples for printing PEG solution in collagen, instead of depositing collagen into PEG containing support bath. This method is termed as “inverted TRACE bioprinting”.

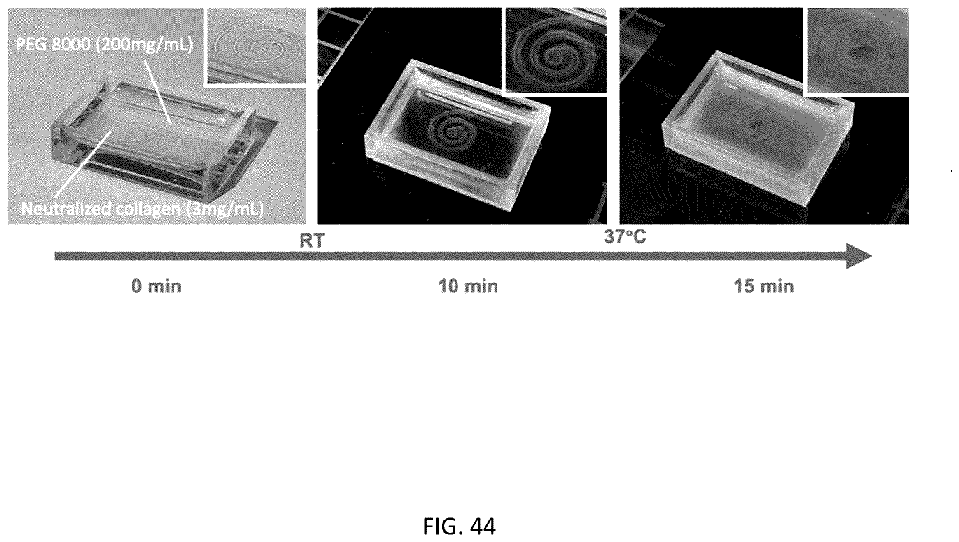

Referring now to FIG. 43, shown is an exemplary schematic for inverted TRACE printing method. PEG 8000 solution can be extruded by a printing nozzle submerged in a neutralized collagen solution in a receptacle. In some embodiments, the printed luminal geometry can vary, depending on PEG fluidic properties, collagen concentration, extrusion pressure, printing speed, and the printing path. In some embodiments, the printing setup comprises a nozzle fluidly connected to a PEG solution reservoir. In some embodiment, the movement of the nozzle can be controlled by a printer or by hand.

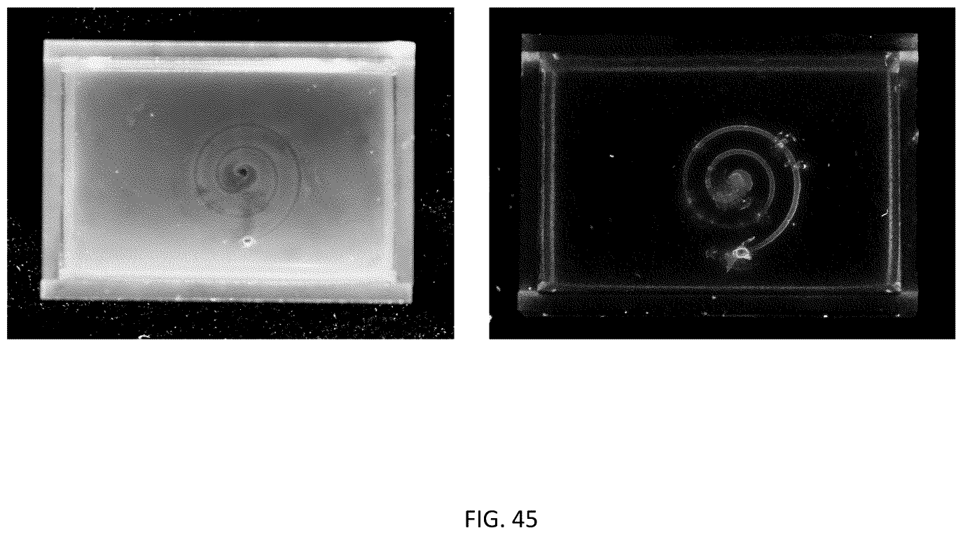

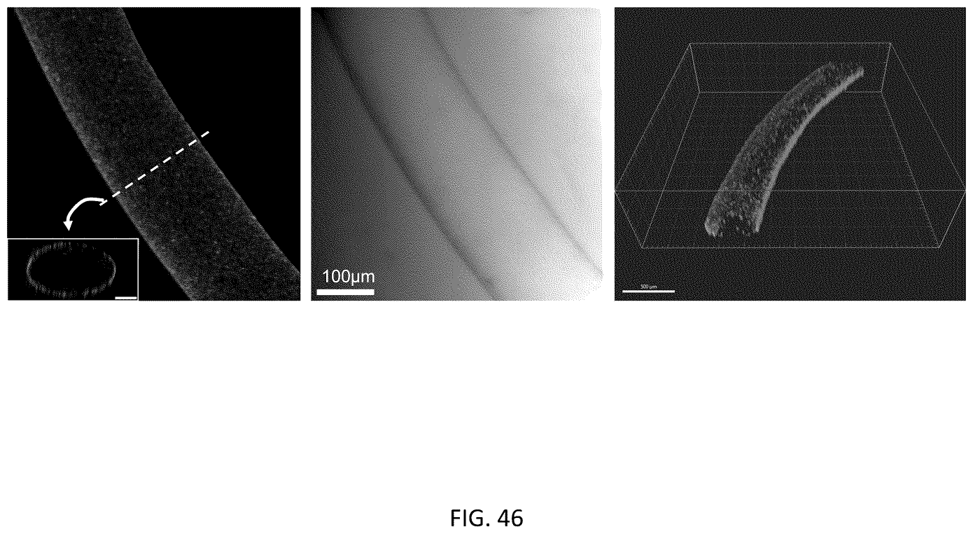

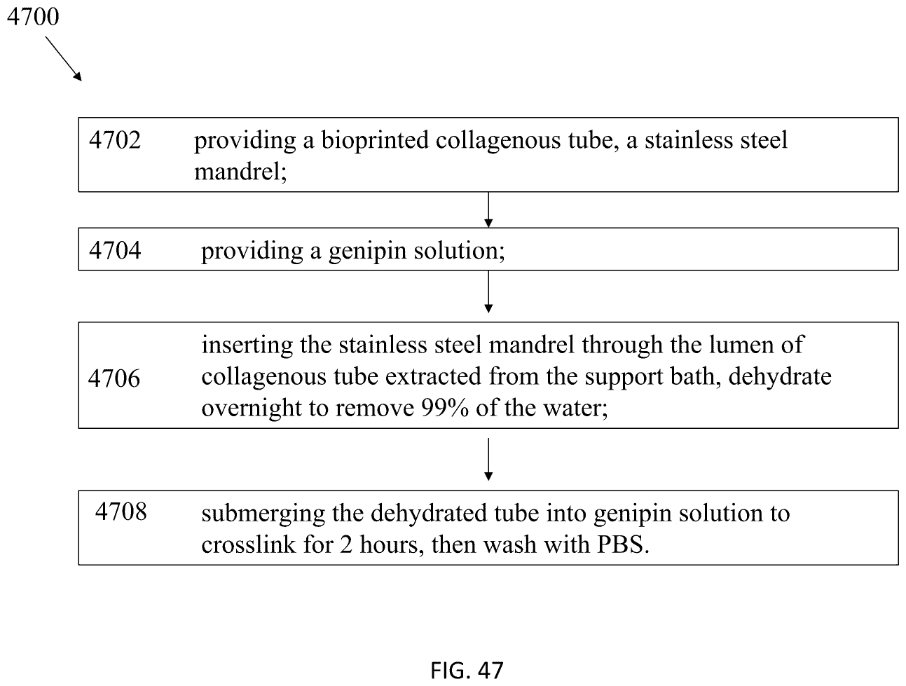

Referring now to FIG. 44, shown is an exemplary post-procedure after the printing step of the inverted printing. In some embodiments, the concentration of the collagen solution is 3 mg/mL. In some embodiments, the receptacle can be a glass cuvette. In some embodiment, the printing solution can be 200 mg/mL PEG solution. In some embodiments, the printing path is a spiral pattern. In some embodiments, the timing and temperature for the incubation is room temperature (RT) for 10 minutes, followed by 37° C. for 15 minutes until the collagen in the cuvette fully gels. In some embodiments, the formed lumen in the collagen can be perfused with a solution with fluorescent microbeads that can be lit up under UV (FIG. 45). In some embodiments, the microbeads can adhere on the formed lumen and be used to visualize the 3D luminal structure (FIG. 46).

### Example 6: Post-Crosslink of TRACE Bioprinted Collagen Tube

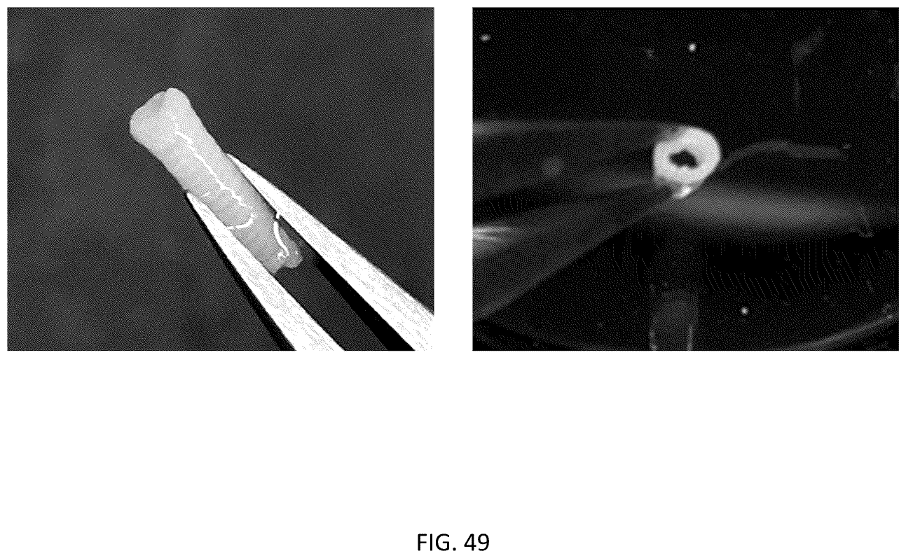

Referring now to FIG. 48, depicted an exemplary TRACE bioprinted tube dehydrated and crosslinked with genipin. In some embodiments, the mandrel that is inserted through the lumen of the bioprinted collagen tube to provide structural support and prevent deformation during handling and dehydration can be stainless steel, glass or coated with anti-adhesion chemicals. In some embodiments, the post-crosslink method comprises the elimination of any percentage of water from the collagen tube via dehydration around the mandrel. In some embodiments, the post-crosslink method comprises crosslinking of bioprinted collagen tubes with genipin at varying concentrations for a specific duration to enhance its mechanical properties, including but not limited to suture retention strength and burst pressure.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

1. A bioprinting system comprising:
a 3D bioprinter with a nozzle;
at least one bioink; and
a support bath solution
comprising PEG (polyethylene glycol) and agarose.

2. The bioprinting system of claim 1, wherein the at least one bioink comprises at least one material selected from the group consisting of: collagen I, ECM proteins, fibrin, basement membrane proteins, Matrigel, Geltrex, collagen IV, laminin, collagen of any type from any species, growth factors, cell culture media, phosphate-buffered saline (PBS), any pH buffering solution, NaOH, any pH neutralizing or modifying solution, glycosaminoglycans, hyaluronic acid, dextran, acid solubilized collagen I solution, neutralized collagen I solution, solution of pre-formed collagen fibers or fiber bundles.

3. The bioprinting system of claim 2, wherein the at least one bioink further comprises one or more cells selected from the group consisting of: induced pluripotent stem cells, stem cells of any type, endothelial cells, primary cells, cell lines, cancer cells, or mammalian cells, any cell type.

4. The bioprinting system of claim 1, wherein the support bath further comprises materials selected from the group consisting of: agarose, agarose slurry, gelatin, gelatin slurry, PBS, water, water-soluble polymer, PEG of molecular weight 8000 Da, PEG of molecular weight 20000 Da, PEG of any molecular weight between 8000 and 20000 Da, PEG of any molecular weight between 0-8000 Da, PEG of any molecular weight, methylcellulose, dextran, and any viscosity modifying reagent.

5-6. (canceled)

7. The bioprinting system of claim 61, wherein the nozzle comprises:
a first and second lumen;
a first bioink reservoir containing a collagenous bioink fluidly connected to the first lumen; and
a second bioink reservoir containing a bioink comprising PEG fluidly connected to the second lumen.

8. (canceled)

9. A method of printing a biological structure, comprising the steps of:
providing the system of claim 1;
submerging the nozzle of the bioprinter into the support bath solution;
extruding the at least one bioink into the support bath solution;
forming a 3D structure with the bioink.

10-11. (canceled)

12. The method of claim 9, further comprising the steps of:
extracting the biological structure out of the support bath solution;
washing the support bath solution away from the biological structure; and
seeding the biological structure with one or more cells after the extracting and washing steps.

13. The method of claim 12, further comprising the step of dehydrating the biological structure.

14. The method of claim 13, further comprising the step of crosslinking the biological structure with one or more crosslinking agents.

15. The method of claim 14, further comprising the step of conditioning the biological structure with mechanical conditioning.

16. (canceled)

17. A biological structure, as printed by the steps of claim 9.

18. The biological structure of claim 17, wherein the structure is any of a soft tissue structure, a cartilaginous structure, a connective tissue structure, a vascular tissue structure, vascular graft structure, a luminal structure, a hollow structure, and a bone tissue structure.

19. The biological structure of claim 17, wherein the structure is in the shape of an articular cartilage, a nasal cartilage, a tarsal plate, tracheal rings, thyroid cartilage, and arytenoid cartilage.

20. The biological structure of claim 17, wherein the structure is formed as a bone, dental structure, joint, cartilage, skeletal muscle, smooth muscle, cardiac muscle, tendon, menisci, ligament, blood vessel, stent, heart valve, cornea, ear drum, nerve guide, tissue patch or sealant, or a filler for missing tissues and skin.

21-24. (canceled)

25. The biological structure of claim 17, wherein the biological structure is seeded or coated with cells.

26-28. (canceled)

29. The biological structure of claim 17, wherein the biological structure is modified by crosslinking, dehydration or mechanical conditioning.

30-31. (canceled)

32. The method of claim 9, further comprising the step of tuning a gelation or solidification speed of the at least one bioink.

33. The method of claim 9, further comprising the steps of:
printing material layers of the at least one bioink; and
merging the printed layers by overfilling each layer with excess bioink material.

34-38. (canceled)

39. The bioprinting system of claim 1, wherein the resolution of the printed feature is altered by modifying by any of: translational speed of the nozzle during printing, extrusion rate of the bioink during printing, nozzle diameter size, support bath components, bioink components.

40. A bioprinting system comprising:
a 3D bioprinter with a nozzle;
at least one bioink comprising PEG (polyethylene glycol) and agarose; and
a support bath solution comprising a collagenous solution.

41-44. (canceled)
